(19) United States
(12) Patent Application Publication
(10) Pub. No.: US 2026/0177899 A1
(43) Pub. Date: Jun. 25, 2026

(54) OPTICAL DEVICE, PROJECTOR, AND IMAGING APPARATUS

(71) Applicant: SEIKO EPSON CORPORATION, Tokyo (JP)

(72) Inventor: Hirotaka YANAGISAWA, Azumino-shi (JP)

(73) Assignee: SEIKO EPSON CORPORATION, Tokyo (JP)

(21) Appl. No.: 19/425,114

(22) Filed: Dec. 18, 2025

(30) Foreign Application Priority Data
Dec. 19, 2024 (JP) 2024-224088

(51) Int. Cl. G03B 21/28

(52) U.S. Cl. CPC G03B 21/28

(57) ABSTRACT

An optical device includes: a first reflective surface having a power; a second reflective surface disposed on a magnification side of the first reflective surface and having a power; and a first optical element disposed on a magnification side of the second reflective surface, in which the first optical element has a first transmissive surface, a third reflective surface having a concave shape in an incident light ray direction, and a second transmissive surface different from the first transmissive surface, which are disposed in order from a reduction side to the magnification side, and at least one of the first transmissive surface, the third reflective surface, and the second transmissive surface has a power.

The present application is based on, and claims priority from JP Application Serial Number 2024-224088, filed Dec. 19, 2024, the disclosure of which is hereby incorporated by reference herein in its entirety.

### BACKGROUND

### 1. Technical Field

The present disclosure relates to an optical device, and a projector and an imaging apparatus including the optical device.

### 2. Related Art

There is known an imaging optical system having one prism on each of a front side and a rear side of an aperture stop (JP-A-11-271618). In the imaging optical system disclosed in JP-A-11-271618, at least one reflective surface of the prism has a power, and at least one optically functional surface of the prism has both a transmission function and a reflection function. A size of the imaging optical system is reduced by utilizing refraction and internal reflection by the prism.

JP-A-11-271618 is an example of the related art.

Since the imaging optical system has functions of transmission and reflection at the same interface of the prism, there is a problem that there is a strict angular constraint for ensuring total internal reflection, thus it is difficult to achieve optical performance such as resolution performance, and it is also difficult to reduce a focal length.

### SUMMARY

An optical device according to one aspect of the disclosure includes: a first reflective surface having a power; a second reflective surface disposed on a magnification side of the first reflective surface and having a power; and a first optical element disposed on a magnification side of the second reflective surface, in which the first optical element has a first transmissive surface, a third reflective surface having a concave shape in an incident light ray direction, and a second transmissive surface different from the first transmissive surface, which are disposed in order from a reduction side to the magnification side, and at least one of the first transmissive surface, the third reflective surface, and the second transmissive surface has a power.

A projector according to an aspect of the disclosure includes: the optical device described above; and an image forming unit configured to form an image on a reduction-side conjugate surface of the optical device.

An imaging apparatus according to an aspect of the disclosure includes: the optical device described above; and an imaging element disposed at a reduction-side conjugate surface of the optical device.

### BRIEF DESCRIPTION OF THE DRAWINGS

FIG. 1 shows a structure of a projector incorporating an optical device according to a first embodiment.

FIG. 2 shows a projection state of the optical device onto a screen.

FIG. 3 is a cross-sectional view showing an optical device or a projection optical system in Example 1.

FIG. 4 shows lateral aberration characteristics of the projection optical system in Example 1.

FIG. 5 shows lateral aberration characteristics of the projection optical system in Example 1.

FIGS. 6A-6B show a relationship between a display surface and a projection surface in Example 1.

FIG. 7 is a cross-sectional view showing an optical device or a projection optical system in Example 2.

FIG. 8 shows lateral aberration characteristics of the projection optical system in Example 2.

FIG. 9 shows lateral aberration characteristics of the projection optical system in Example 2.

FIGS. 10A-10B show a relationship between a display surface and a projection surface in Example 2.

FIG. 11 is a cross-sectional view showing an optical device or a projection optical system according to a second embodiment.

FIG. 12 shows lateral aberration characteristics of a projection optical system in Example 3.

FIG. 13 shows lateral aberration characteristics of the projection optical system in Example 3.

FIGS. 14A-14B show a relationship between a display surface and a projection surface in Example 3.

FIG. 15 is a cross-sectional view showing an optical device or a projection optical system according to a third embodiment.

FIG. 16 shows lateral aberration characteristics of a projection optical system in Example 4.

FIG. 17 shows lateral aberration characteristics of the projection optical system in Example 4.

FIGS. 18A-18B show a relationship between a display surface and a projection surface in Example 4.

FIG. 19 is a cross-sectional view showing an optical device or a projection optical system according to a fourth embodiment.

FIG. 20 shows lateral aberration characteristics of a projection optical system in Example 5.

FIG. 21 shows lateral aberration characteristics of the projection optical system in Example 5.

FIGS. 22A-22B show a relationship between a display surface and a projection surface in Example 5.

FIG. 23 is a cross-sectional view showing an optical device or a projection optical system in Example 6.

FIG. 24 shows lateral aberration characteristics of the projection optical system in Example 6.

FIG. 25 shows lateral aberration characteristics of the projection optical system in Example 6.

FIGS. 26A-26B show a relationship between a display surface and a projection surface in Example 6.

FIG. 27 shows a structure of an imaging apparatus incorporating an optical device according to a fifth embodiment.

### DESCRIPTION OF EMBODIMENTS

### First Embodiment

An optical device according to a first embodiment of the disclosure and a projector incorporating the same will be described below with reference to the drawings.

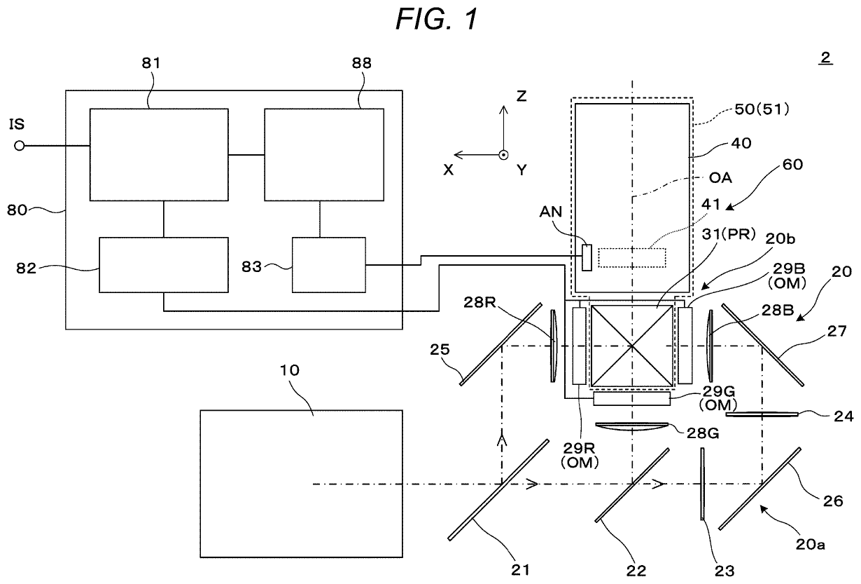

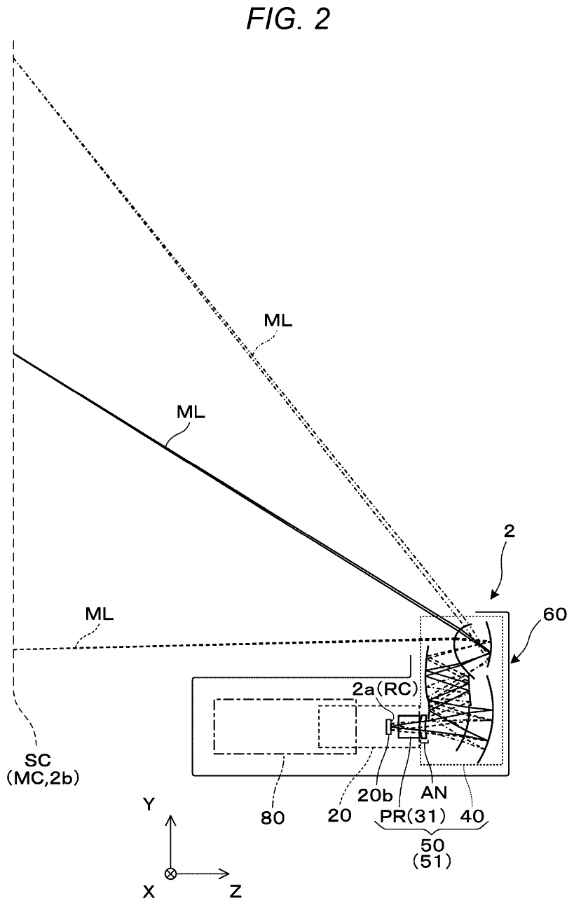

FIG. 1 shows a structure of a projector 2 incorporating an optical device 50 according to the first embodiment. As shown in FIG. 1, the projector 2 includes an optical system portion 60 that projects image light or video light and a circuit device 80 that controls an operation of the optical system portion 60. The optical system portion 60 includes an image display device 20 that displays image light, and a projection optical system 40 that projects the image light onto a screen SC (see FIG. 2).

The image display device 20 includes a light source device 10, a separation optical system 20a, an image forming unit 20b, and a prism PR. In the present embodiment, the optical device 50 is a projection optical device 51, which is a combination of the prism PR and the projection optical system 40. When the image display device 20 has a single-plate structure, another optical member may be provided instead of the prism PR. The prism PR may also be omitted.

The light source device 10 emits light including R light, G light, and B light in a uniform state. The light source device 10 includes: a light source lamp that is, for example, an ultra-high-pressure mercury lamp; a two-stage integrator lens including a plurality of lens elements arranged in an array; a polarization conversion element that converts light having passed through the two-stage integrator lens into predetermined linearly polarized light; and a superimposing lens that superimposes illumination light exiting from a later-stage integrator lens on display regions of liquid crystal panels 29R, 29G, and 29B.

The separation optical system 20a separates the light emitted from the light source device 10 into three colors of R, G, and B. The separation optical system 20a includes a first dichroic mirror 21, a second dichroic mirror 22, relay lenses 23 and 24, reflective mirrors 25, 26, and 27, and field lenses 28R, 28G, and 28B. The image forming unit 20b includes the liquid crystal panels 29R, 29G, and 29B, which are light modulation elements OM.

The first dichroic mirror 21 reflects the R light incident from the light source device 10 and transmits the G light and the B light. The R light reflected by the first dichroic mirror 21 is incident on the liquid crystal panel 29R via the reflective mirror 25 and the field lens 28R. The liquid crystal panel 29R modulates the R light according to an image signal to form an R-color image.

The second dichroic mirror 22 reflects the G light from the first dichroic mirror 21 and transmits the B light. The G light reflected by the second dichroic mirror 22 is incident on the liquid crystal panel 29G via the field lens 28G. The liquid crystal panel 29G modulates the G light according to an image signal to form a G-color image. The B light transmitted through the second dichroic mirror 22 is incident on the liquid crystal panel 29B via the relay lenses 23 and 24, the reflective mirrors 26 and 27, and the field lens 28B. The liquid crystal panel 29B modulates the B light according to an image signal to form a B-color image.

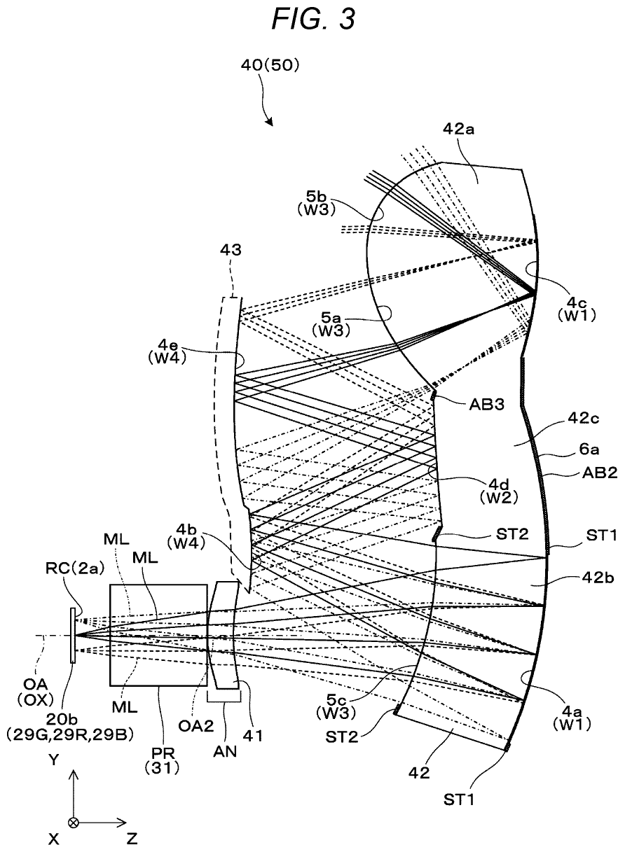

The liquid crystal panels 29R, 29G, and 29B serving as the image forming unit 20b form an image on a reduction-side conjugate surface RC (see FIG. 3) of the projection optical system 40.

The prism PR is, for example, a cross dichroic prism 31. The cross dichroic prism 31 is a light combining prism, which combines the light modulated by the liquid crystal panels 29R, 29G, and 29B into image light and causes the image light to travel to the projection optical system 40.

The projection optical system 40 is a projection lens that magnifies the image light modulated by the liquid crystal panels 29R, 29G, and 29B and combined by the cross dichroic prism 31, and projects the magnified image light onto the screen SC (see FIG. 2).

The circuit device 80 includes an image processing unit 81 that receives an external image signal IS such as a video signal, a display drive unit 82 that drives the liquid crystal panels 29R, 29G, and 29B provided in the optical system portion 60 based on an output from the image processing unit 81, a lens drive unit 83 that adjusts a state of the projection optical system 40 by operating a moving mechanism AN provided in the projection optical system 40, and a main control unit 88 that comprehensively controls operations of such circuit portions 81, 82, and 83.

The image processing unit 81 converts the received external image signal IS into an image signal including gradations of each color and the like. The image processing unit 81 can also perform various types of image processing, such as distortion correction and color correction, on the external image signal IS.

The display drive unit 82 can operate the liquid crystal panels 29R, 29G, and 29B based on the image signal output from the image processing unit 81, and can cause the liquid crystal panels 29R, 29G, and 29B to form an image corresponding to the image signal or an image corresponding to the image signal subjected to image processing.

The lens drive unit 83 operates under control of the main control unit 88 and adjusts a focus of the projection optical system 40 by appropriately moving a lens 41 constituting the projection optical system 40 or the optical device 50 along an apparatus optical axis OA by the moving mechanism AN. Here, the apparatus optical axis OA is an axis passing through a center of the lens 41 or a central axis OX passing through a center of the reduction-side conjugate surface RC in the optical device 50 (see FIG. 3). The moving mechanism AN includes, for example, an actuator.

The lens drive unit 83 can be omitted. In this case, the focus adjustment of the projection optical system 40 may be performed by manually moving the lens 41 using a mechanical mechanism including a cam mechanism or the like as the moving mechanism AN.

Hereinafter, the optical device 50 will be specifically described with reference to FIGS. 2 and 3. FIG. 2 shows a projection state of the optical device 50 onto the screen SC. FIG. 3 shows a configuration and a light ray diagram of the optical device 50. The optical device 50 shown as an example in FIG. 3 has the same configuration as the optical device 50 in Example 1 to be described later.

As shown in FIG. 2, the optical device 50 includes the prism PR and the projection optical system 40. The optical device 50 projects an image formed on a display surface 2a or a surface to be projected of the image forming unit 20b onto a projection surface 2b of the screen SC. That is, image light ML emitted from the display surface 2a of the image forming unit 20b is incident on the projection surface 2b of the screen SC via the prism PR and the projection optical system 40. The prism PR corresponding to the cross dichroic prism 31 in FIG. 1 is disposed between the optical device 50 and the image forming unit 20b.

As shown in FIG. 3, the projection optical system 40 of the optical device 50 includes the lens 41, a first internal reflection element 42, and a mirror element 43. The projection optical system 40 is an eccentric or off-axis optical system, and the apparatus optical axis OA extending along an optical path through a center of the image forming unit 20b is disposed along a symmetry plane parallel to a YZ plane. That is, the projection optical system 40 is asymmetric relative to an up-down Y direction, and is symmetric relative to the YZ plane. The optical device 50 includes, as general elements, a first reflective surface 4a having a power, a second reflective surface 4b disposed on a magnification side of the first reflective surface 4a and having a power, and a first optical element 42a disposed on a magnification side of the second reflective surface 4b. As will be described in detail later, the first optical element 42a is contained in the first internal reflection element 42.

The lens 41 is a positive lens disposed between the first reflective surface 4a and the reduction-side conjugate surface RC of the optical device 50 or the projection optical system 40. Accordingly, a reduction side of the optical device 50 can be made telecentric. In addition, it is possible to reduce a size of the entire optical system of the optical device 50 by reducing light beam spread. The term “telecentric” includes a case of being substantially telecentric where a chief ray is substantially parallel to the apparatus optical axis OA. The lens 41 can be moved along a lens optical axis OA2 of the lens 41 or the central axis OX of the reduction-side conjugate surface RC by the moving mechanism AN. Accordingly, a focus function can be implemented in the optical device 50.

The first internal reflection element 42 includes the first optical element 42a, a second optical element 42b, and a third optical element 42c. That is, the first optical element 42a, the second optical element 42b, and the third optical element 42c are the integrated first internal reflection element 42. The first internal reflection element 42 is an internal-reflection-type refractive optical element having both an internal reflection function and a refractive function in one element. Since the first to third optical elements 42a to 42c are formed of the same element, it is possible to reduce cost and improve assembly accuracy. As will be described in detail later, one or more reflective surfaces of the first internal reflection element 42 serve as an internal reflective surface W1. The first internal reflection element 42 is formed of a light transmissive member. Examples of the light transmissive member include resins and glass.

The first optical element 42a is disposed on a magnification side or an upper side in the first internal reflection element 42. The first optical element 42a has a first transmissive surface 5a, a third reflective surface 4c having a concave shape in an incident light ray direction, and a second transmissive surface 5b different from the first transmissive surface 5a, which are arranged in order from the reduction side toward the magnification side. That is, in the first optical element 42a and thus in the first internal reflection element 42, a final reflective surface on the magnification side has a concave shape. The third reflective surface 4c is the internal reflective surface W1 that reflects or back-reflects light inside the first optical element 42a. Since the first optical element 42a has the first transmissive surface 5a and the second transmissive surface 5b, a transmissive surface through which incident light passes (incident surface) and a transmissive surface through which exit light passes (exit surface) are provided in different regions in the first optical element 42a. Accordingly, the incident surface and the exit surface of the first optical element 42a can have different functions to improve optical performance.

A boundary (not shown) is provided between the first transmissive surface 5a and the second transmissive surface 5b. At the boundary, a light-absorbing member may be provided to prevent incident light onto the first optical element 42a or reflected light from leaking to an unintended optical path and returning to an intended optical path from another location.

At least one of the first transmissive surface 5a, the third reflective surface 4c, and the second transmissive surface 5b has a power in the embodiment. In the embodiment, the first transmissive surface 5a, the third reflective surface 4c, and the second transmissive surface 5b each have a positive power. Accordingly, since refractive powers of the first transmissive surface 5a and the second transmissive surface 5b close to the third reflective surface 4c can be used, light ray control is facilitated, which is advantageous for size reduction and performance improvement of the optical device 50. Signs of powers of the first transmissive surface 5a, the third reflective surface 4c, and the second transmissive surface 5b can be appropriately changed, and the third reflective surface 4c and the second transmissive surface 5b preferably have positive powers.

In the optical device 50, an intermediate image is formed between the first transmissive surface 5a and the third reflective surface 4c. That is, the intermediate image is formed in the first optical element 42a. Accordingly, the intermediate image is formed on a reduction side optical path of the third reflective surface 4c, the intermediate image is re-imaged on the concave third reflective surface 4c, and thus a focal length can be shortened.

The second optical element 42b is disposed on a reduction side or a lower side in the first internal reflection element 42. The second optical element 42b has the first reflective surface 4a and a third transmissive surface 5c. The third transmissive surface 5c transmits both incident light incident on the first reflective surface 4a and reflected light reflected by the first reflective surface 4a. Since an incident light ray onto the second optical element 42b and an exit light ray pass through the third transmissive surface 5c that is the same refractive surface W3, light ray control that cannot be implemented by surface reflections is enabled, and optical performance can be improved while saving space.

A first aperture stop ST1 is disposed at the first reflective surface 4a. The first aperture stop ST1 is associated with the first reflective surface 4a and is formed outside an effective light ray passage region of the first reflective surface 4a to surround the effective light ray passage region. The first aperture stop ST1 absorbs light passing through the outside of the effective light ray passage region of the first reflective surface 4a. In particular, when the optical device 50 is used as the projection optical device 51, light emitted from the liquid crystal panel 29G or the like, which is a display device, is regulated by the first aperture stop ST1 at an initial stage of the optical system, and thus it is possible to prevent an unnecessary stray reflection in the optical system of the optical device 50.

A second aperture stop ST2 is disposed at the third transmissive surface 5c. The second aperture stop ST2 is associated with the third transmissive surface 5c and is formed outside an effective light ray passage region of the third transmissive surface 5c to surround the effective light ray passage region. The second aperture stop ST2 absorbs light passing through the outside of the effective light ray passage region of the third transmissive surface 5c. By providing the second aperture stop ST2, that is, by providing an aperture stop function to the internal-reflection-type second optical element 42b having the first reflective surface 4a, light ray control at an aperture stop position is facilitated, which is advantageous for improving optical performance.

The third optical element 42c is disposed between the first optical element 42a and the second optical element 42b in the first internal reflection element 42. The third optical element 42c has a fourth reflective surface 4d disposed on the magnification side of the second reflective surface 4b of the mirror element 43 to be described later.

In the third optical element 42c, a second light-absorbing member AB2 is disposed at a back surface 6a that is a surface opposite to the fourth reflective surface 4d between the first reflective surface 4a and the third reflective surface 4c in a vertical direction that is the Y direction. Accordingly, it is possible to shield unnecessary light that is reflected by the first reflective surface 4a and the third reflective surface 4c and causes stray light. Examples of a material of the second light-absorbing member AB2 include a paint or another substance having light-absorbing properties, and a light-shielding film. Since the fourth reflective surface 4d that is a surface reflective surface W2 also shields unnecessary light reflected by the back surface 6a, the second light-absorbing member AB2 can be omitted.

In the third optical element 42c, a third light-absorbing member AB3 for preventing stray light may be provided around the fourth reflective surface 4d.

The mirror element 43 is disposed spatially in a −Z direction relative to the first internal reflection element 42, that is, on the reduction-side conjugate surface RC side. The mirror element 43 has the second reflective surface 4b and a fifth reflective surface 4e. The second and fifth reflective surfaces 4b and 4e are a surface reflective surface W4 that reflects incident light on a surface of the mirror element 43. The second and fifth reflective surfaces 4b and 4e face the first internal reflection element 42 at positions closer to a center so as to avoid upper and lower ends of the first internal reflection element 42. That is, the second and fifth reflective surfaces 4b and 4e are spatially disposed on the reduction-side conjugate surface RC side relative to the third reflective surface 4c. The second reflective surface 4b is disposed spatially below the optical device 50, that is, on the reduction side. The second reflective surface 4b is also disposed between the third transmissive surface 5c and the fourth reflective surface 4d on the optical path. The fifth reflective surface 4e is disposed spatially above the optical device 50, that is, on the magnification side. The fifth reflective surface 4e is also disposed between the fourth reflective surface 4d and the first transmissive surface 5a on the optical path. The mirror element 43 is integrally formed such that the fifth and second reflective surfaces 4e and 4b are arranged side by side in the up-down direction. Accordingly, it is possible to reduce the size and cost of the optical system of the optical device 50. A base material of the mirror element 43 is made of, for example, a resin or a metal.

A boundary (not shown) is provided between the second reflective surface 4b and the fifth reflective surface 4e.

In the above description, focusing on the optical surfaces of the first internal reflection element 42 and the mirror element 43, the optical device 50 has the third transmissive surface 5c, the first reflective surface 4a, the third transmissive surface 5c, the second reflective surface 4b, the fourth reflective surface 4d, the fifth reflective surface 4e, the first transmissive surface 5a, the third reflective surface 4c, and the second transmissive surface 5b in order from the reduction side to the magnification side on the optical path. In the optical device 50, the image light ML is reflected five times. Since the optical device 50 includes the plurality of reflective surfaces 4a to 4e in a direction of magnified projection relative to the central axis OX of the reduction-side conjugate surface RC, which is a reduction-side imaging surface, it is possible to minimize a reflection angle and prevent a decrease in optical performance.

Focusing on the optical surfaces of the first internal reflection element 42 in a cross-sectional view, the third transmissive surface 5c, the fourth reflective surface 4d, the first transmissive surface 5a, and the second transmissive surface 5b are disposed on the second reflective surface 4b side. The second light-absorbing member AB2 and the third reflective surface 4c are disposed on the first reflective surface 4a side. In this way, the internal reflective surface W1, the surface reflective surface W2, and the refractive surface W3 can be disposed at the first internal reflection element 42, which is advantageous for size reduction. Specifically, the internal reflective surface W1 corresponds to the first and third reflective surfaces 4a and 4c. The surface reflective surface W2 corresponds to the fourth reflective surface 4d. The refractive surface W3 corresponds to the first to third transmissive surfaces 5a to 5c.

In the first internal reflection element 42, the internal reflective surface W1 and the surface reflective surface W2 may each be formed with a metal thin film of aluminum, silver, or the like on a surface thereof, or may each be formed with a dielectric multilayer film on the surface. The refractive surface W3 has a surface formed with an anti-reflection film. On the reduction-side conjugate surface RC side of the first internal reflection element 42, the surface reflective surface W2 and the refractive surface W3 are provided on a continuous surface, and a reflective film constituting the surface reflective surface W2 and the anti-reflection film constituting the refractive surface W3 are formed in corresponding regions.

In the mirror element 43, the surface reflective surface W4 may be a reflective surface whose surface is formed with a metal thin film of aluminum, silver, or the like, or may be a reflective surface whose surface is formed with a dielectric multilayer film.

Hereinafter, the optical path and the like of the optical device 50 will be described. Image light from the image forming unit 20b is incident on the third transmissive surface 5c of the first internal reflection element 42 via the prism PR and the lens 41. The light having passed through the third transmissive surface 5c is appropriately refracted and internally reflected by the first reflective surface 4a. The light reflected by the first reflective surface 4a passes through the third transmissive surface 5c again. The light exiting from the third transmissive surface 5c and appropriately refracted is reflected by the second reflective surface 4b of the mirror element 43. The light reflected by the second reflective surface 4b is surface-reflected by the fourth reflective surface 4d of the first internal reflection element 42 and is reflected by the fifth reflective surface 4e of the mirror element 43. The light reflected by the fifth reflective surface 4e is incident on the first transmissive surface 5a of the first internal reflection element 42. The light having passed through the first transmissive surface 5a is appropriately refracted and internally reflected by the third reflective surface 4c. The light reflected by the third reflective surface 4c passes through the second transmissive surface 5b different from the first transmissive surface 5a. The light exiting from the second transmissive surface 5b and appropriately refracted is projected onto the screen SC (see FIG. 2).

The optical device 50 described above includes the first reflective surface 4a having a power, the second reflective surface 4b disposed on the magnification side of the first reflective surface 4a and having a power, and the first optical element 42a disposed on the magnification side of the second reflective surface 4b. The first optical element 42a includes the first transmissive surface 5a, the third reflective surface 4c having a concave shape in an incident light ray direction, and the second transmissive surface 5b different from the first transmissive surface 5a, which are disposed in order from the reduction side to the magnification side. At least one of the first transmissive surface 5a, the third reflective surface 4c, and the second transmissive surface 5b has a power.

In the optical device 50 described above, light ray control is facilitated using refractive powers of the first transmissive surface 5a and the second transmissive surface 5b close to the third reflective surface 4c that is the internal reflective surface W1 of the first optical element 42a, which is advantageous for size reduction and performance improvement. In addition, the first transmissive surface 5a and the second transmissive surface 5b can provide different functions to the incident surface and the exit surface of the first optical element 42a, and thus optical performance can be improved. In addition, since the third reflective surface 4c is the internal reflective surface W1, the third reflective surface 4c can be reduced in size, and thus the entire optical system can be reduced in size. Based on the above, a focal length of the optical device 50 can be shortened and a size of the optical device 50 can be reduced.

When a projection optical system is implemented only by a refractive optical system as in the related art, the projection optical system has a large number of lenses for a spherical lens shape and chromatic aberration correction, and thus becomes a linear projection lens having a long overall length. In contrast, in the optical device 50 of the disclosure, a three-dimensional optical system can be obtained using the plurality of reflective surfaces and the plurality of refractive surfaces. In addition, in the first internal reflection element 42, since a reflective surface formed by molding is used, the surface is not limited to a spherical shape, and a projection system can be obtained with a small number of surfaces and a small number of components by effectively using a correction function by an aspherical shape or a freeform surface shape on each surface. As a result, it is possible to shorten an overall length of the optical system and to implement a configuration in which light is folded back and projected to the image forming unit 20b. In particular, when a focal length is shortened, an apparatus main body can be disposed in a projection space, and a projection configuration having improved usability can be obtained.

When a projection optical system is implemented only by a surface reflection element as in the related art, the projection optical system is a large optical system having a large number of reflective surfaces. In contrast, in the optical device 50 of the disclosure, using the first internal reflection element 42 that is an internal-reflection-type refractive optical element, it is possible to reduce the number of reflective surfaces and obtain a compact optical system by utilizing a refraction effect at a transmission interface.

Specifically, by forming a final reflective surface on the magnification side, specifically, the third reflective surface 4c, in a concave shape, an intermediate image formed in front of the third reflective surface 4c can be magnified and projected to implement wide-angle projection. In addition, by providing the first aperture stop ST1 at an initial reflective surface from the image forming unit 20b, specifically, at the first reflective surface 4a, it is possible to shield unnecessary light at an initial stage and obtain a small optical system. By providing the first internal reflection element 42 with the first reflective surface 4a where the first aperture stop ST1 is set, light ray control is enabled in the vicinity of the aperture stop position, and a relatively bright optical system can be obtained.

In the optical device 50, the optical elements or the optical surfaces are collectively disposed in the up-down direction, and thus the elements can be coupled to form one component. Since shapes of a plurality of surfaces can be produced at once by integrally molding the optical elements, it is possible to obtain an optical system where assembly accuracy is ensured while reducing the number of components.

As described above, although the optical device 50 has a wide angle, the optical device 50 is a small device having high brightness and high image quality.

The projector 2 described above includes the optical device 50 described above and the image forming unit 20b that forms an image on the reduction-side conjugate surface RC of the optical device 50. Accordingly, the projector 2 including the optical device 50 can thus be reduced in size.

### EXAMPLES

Hereinafter, examples of the optical device 50 will be described.

As a common feature in the following Example 1 and the like, a displacement z of an aspherical surface is specified by the following polynomial (aspherical surface formula).

$$z = \frac{{ch}^{2}}{1 + \sqrt{1 - ( k + 1 ) {c}^{2} {h}^{2}}} + {ΣA}_{i} {h}^{i}$$

where
c: curvature (1/R)
   h: height from optical axis
   k: conic constant
   Ai: i-th order aspherical coefficient

The displacement z of an XY polynomial surface is specified by the following polynomial.

$$z = \frac{{cr}^{2}}{1 + \sqrt{1 - ( 1 + k ) {c}^{2} {r}^{2}}} + \sum {c}_{mn} {x}^{m} {y}^{n}$$

where
c: curvature (1/R)
   k: conic constant
   Cₘₙ: coefficient of monomial x^{m}yⁿ
   r: radial distance (r=√(x²+y²)

### Example 1

Table 1 shows optical surface data in Example 1. Terms in Table 1 and the following tables are shown below. A surface number 1 means the reduction-side conjugate surface RC, and a last surface number means a magnification-side conjugate surface MC. “T-C” means that reference is made to an eccentricity setting table. Data of surface numbers not corresponding to the optical elements shown in FIG. 3 is dummy data.
SuNo: surface number
SuTy: surface type
Mt: material
SuFu: surface function (refraction or reflection)
SP: spherical surface
NP: aspherical surface
XY-FS: XY polynomial surface
INF: infinity
OM1: SBSL7_OHARA
OM2: refractive index; 1.516745, Abbe number; 67.43
OM3: Z-330R
DK: refractive surface
RH: reflective surface
R: paraxial radius of curvature (unit: mm)
D: axial spacing (unit: mm)
Ar: aperture radius (unit: mm)

TABLE 1

| SuNo | SuTy | R | D | Mt | SuFu | Ar |
|---|---|---|---|---|---|---|
| 1 | SP | INF | 9.5000 | | DK | 7.5472 |
| 2 | SP | INF | 25.9100 | OM1 | DK | 9.2096 |
| 3 | SP | INF | 0.1000 | | DK | 12.3490 |
| 4 | NP | 28.8770 | 6.9428 | OM2 | DK | 12.8011 |
| 5 | NP | 47.6057 | 1.4383 | | DK | 13.0167 |
| 6 | SP | INF | T-C | | DK | 13.4207 |
| 7 | NP | −94.0326 | T-C | OM3 | DK | 56.3488 |
| 8 | NP | −118.4506 | T-C | OM3 | RH | 24.6180 |
| 9 | NP | −94.0326 | T-C | | DK | 61.1608 |
| 10 | XY-FS | −96.6316 | T-C | | RH | 34.1892 |
| 11 | XY-FS | 116.8783 | T-C | | RH | 70.2483 |
| 12 | XY-FS | 291.7526 | T-C | | RH | 58.1977 |
| 13 | NE | 41.5495 | T-C | OM3 | DK | 40.5669 |
| 14 | NP | −63.1738 | T-C | OM3 | RH | 25.6137 |
| 15 | NE | 24.5897 | T-C | | DK | 24.1499 |
| 16 | SP | INF | 0.0000 | | DK | 112.8491 |
| 17 | SP | INF | −608.6860 | | DK | 112.8491 |
| 18 | SP | INF | 0.0000 | | DK | 998.8233 |

Table 2 shows an eccentricity setting of Example 1. Terms in Table 2 and the following tables are shown below. An X axis is an axis in a direction perpendicular to the plane of the sheet, and a depth direction is defined as +. In addition, α rotation is clockwise rotation relative to the X axis when observed in the +X direction. A unit of distance is mm, and a unit of angle is °.
Ec: eccentricity
XEc: X eccentricity
YEc: Y eccentricity
ZEc: Z eccentricity
αRo: α rotation
Nr: normal
N/A: none
dc & re: decenter and return

TABLE 2

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | N/A | — | — | — | — |
| 5 | N/A | — | — | — | — |
| 6 | dc & re | — | — | 3.0000 | — |
| 7 | dc & re | — | −37.3662 | 30.9474 | −40.3930 |
| 8 | dc & re | — | −4.1776 | 80.0000 | −11.8012 |
| 9 | dc & re | — | −37.3662 | 30.9474 | −40.3930 |
| 10 | dc & re | — | 46.7505 | 0.0000 | 15.4661 |
| 11 | dc & re | — | −2.8256 | 62.0106 | 20.7235 |
| 12 | dc & re | — | 81.6189 | 0.0000 | −5.6859 |
| 13 | dc & re | — | 100.5863 | 34.3353 | 1.4988 |
| 14 | dc & re | — | 100.5863 | 80.0000 | 1.4988 |
| 15 | dc & re | — | 100.5863 | 34.3353 | 1.4988 |
| 16 | nr | — | — | 80.0000 | — |

Table 3 shows aspherical surface data in Example 1. Terms in Table 3 and the following tables are shown below. Each item in the table is expressed in a two-tier format. In Table 3 and the following tables, a power of 10 (1.00×10⁺¹⁸, for example) is expressed using E (1.00E+18, for example).
A: fourth-order aspherical coefficient
B: sixth-order aspherical coefficient
C: eighth-order aspherical coefficient

TABLE 3

| SuNo | 4 | 5 | 7 | 8 | 9 | 13 | 14 | 15 |
|---|---|---|---|---|---|---|---|---|
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |

[symbol]

indicates data missing or illegible when filed

Table 4 shows XY polynomial surface data in Example 1. In Table 4 and the following tables, C-xmyn means a coefficient Cₘₙ of a term x^{m}yⁿ (m and n are integers of 0 or more). When m and n are 0, or x^{m} or yⁿ is 1, the term is not shown.

TABLE 4

| SuNo | 10 | 11 | 12 |
|---|---|---|---|
| R | −96.6316 | 116.8783 | 291.7526 |
| k | −0.0772 | 0.7438 | 16.6250 |
| C-x4 | −2.90007E−07 | 1.06165E−06 | 1.05110E+01 |
| C-x2y2 | −5.09409E−08 | −2.36731E−06 | 1.84650E+01 |
| C-y4 | −1.67407E−07 | −2.56278E−07 | 7.90174E+00 |
| C-x6 | 9.59623E−10 | −4.03104E−10 | −1.02890E+01 |
| C-x4y2 | 3.17737E−10 | 1.51031E−10 | −2.47269E+01 |
| C-x2y4 | 2.14788E−10 | 5.34443E−10 | −2.43574E+01 |
| C-y6 | 1.04278E−10 | −9.22891E−11 | −6.86895E+00 |
| C-x8 | 2.58292E−13 | −7.24293E−13 | 6.67097E+00 |
| C-x6y2 | −1.46208E−12 | 1.64145E−13 | 2.55089E+01 |
| C-x4y4 | −2.13827E−13 | −9.37039E−14 | 3.24116E+01 |
| C-x2y6 | −2.19981E−13 | −4.83831E−14 | 2.12806E+01 |
| C-y8 | −5.24404E−14 | 1.92004E−14 | 3.70168E+00 |
| C-x10 | 0 | 1.86064E−15 | 7.98339E−01 |
| C-x82 | 0 | −1.3112E−16 | −1.53734E+01 |
| C-x6y4 | 0 | 2.60133E−17 | −2.31288E+01 |
| C-x4y6 | 0 | 7.50031E−18 | −2.05257E+01 |
| C-x2y8 | 0 | 3.65135E−19 | −1.08005E+01 |
| C-y10 | 0 | −1.46754E−18 | −1.36452E+00 |

FIG. 3 is a cross-sectional view of the optical device 50 in Example 1.

The optical device 50 includes the prism PR, the lens 41, the first internal reflection element 42, and the mirror element 43. The first internal reflection element 42 is formed by integrating the first optical element 42a, the second optical element 42b, and the third optical element 42c. The third optical element 42c is disposed between the first optical element 42a and the second optical element 42b. The mirror element 43 faces the first internal reflection element 42.

The first optical element 42a has the first transmissive surface 5a, the third reflective surface 4c, and the second transmissive surface 5b. The third reflective surface 4c is the concave internal reflective surface W1. In the first optical element 42a, the refractive surface W3 through which incident light and reflected light pass is an optical surface different between the first transmissive surface 5a and the second transmissive surface 5b. The first transmissive surface 5a, the third reflective surface 4c, and the second transmissive surface 5b each have a positive power.

The second optical element 42b has the first reflective surface 4a and the third transmissive surface 5c. The first reflective surface 4a is the concave internal reflective surface W1. In the second optical element 42b, the refractive surface W3 through which incident light and reflected light pass is the single third transmissive surface 5c and is a common optical surface. The first aperture stop ST1 is disposed at the first reflective surface 4a. The second aperture stop ST2 is disposed at the third transmissive surface 5c.

The third optical element 42c has the fourth reflective surface 4d that is the surface reflective surface W2. The back surface 6a opposite to the fourth reflective surface 4d is a substantially smooth surface as a whole and is not an optical surface. The second light-absorbing member AB2 is disposed at the back surface 6a.

The mirror element 43 has the second reflective surface 4b that is the surface reflective surface W4 and the fifth reflective surface 4e that is the surface reflective surface W4. The second and fifth reflective surfaces 4b and 4e are integrated.

The optical device 50 has the third transmissive surface 5c, the first reflective surface 4a, the third transmissive surface 5c, the second reflective surface 4b, the fourth reflective surface 4d, the fifth reflective surface 4e, the first transmissive surface 5a, the third reflective surface 4c, and the second transmissive surface 5b in order from the reduction side to the magnification side on the optical path. The third transmissive surface 5c, the fourth reflective surface 4d, the first transmissive surface 5a, and the second transmissive surface 5b are disposed on the second reflective surface 4b side. The second light-absorbing member AB2 and the third reflective surface 4c are disposed on the first reflective surface 4a side.

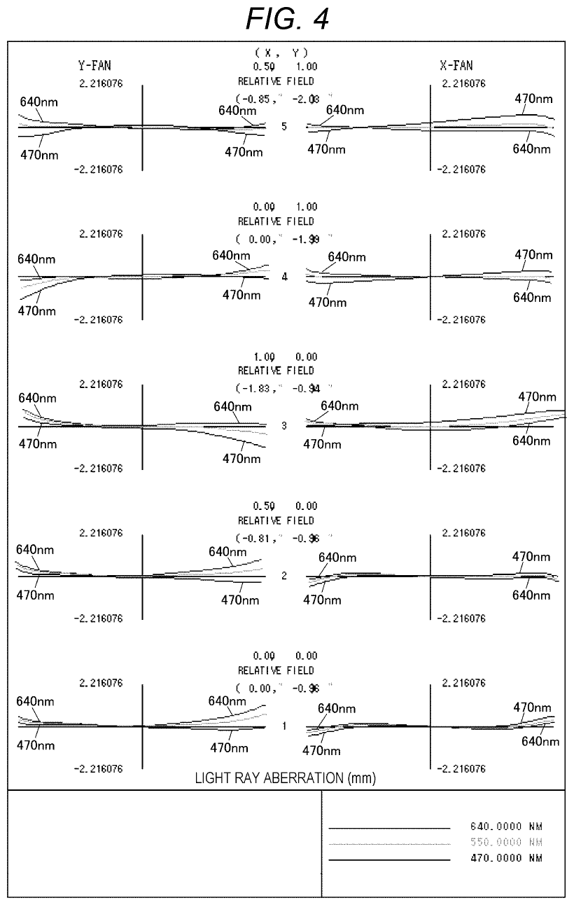

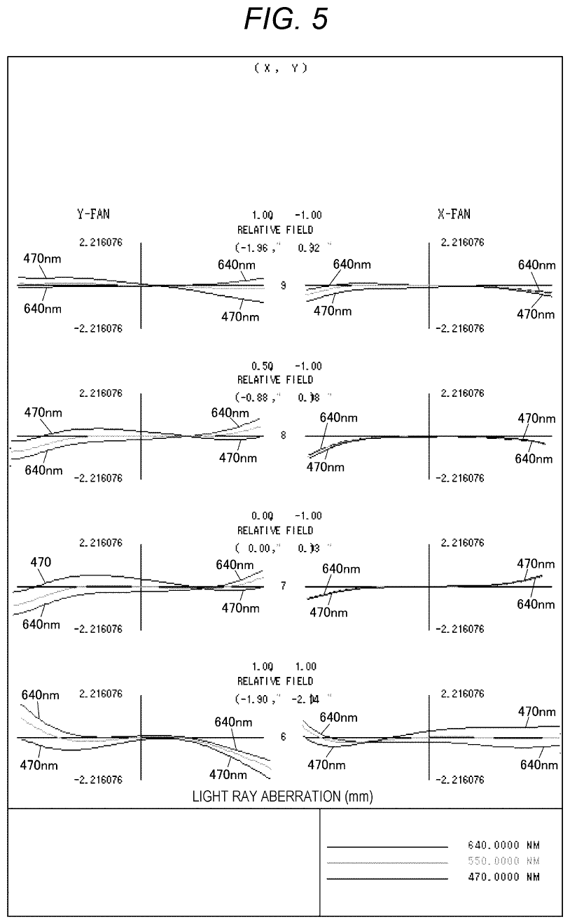

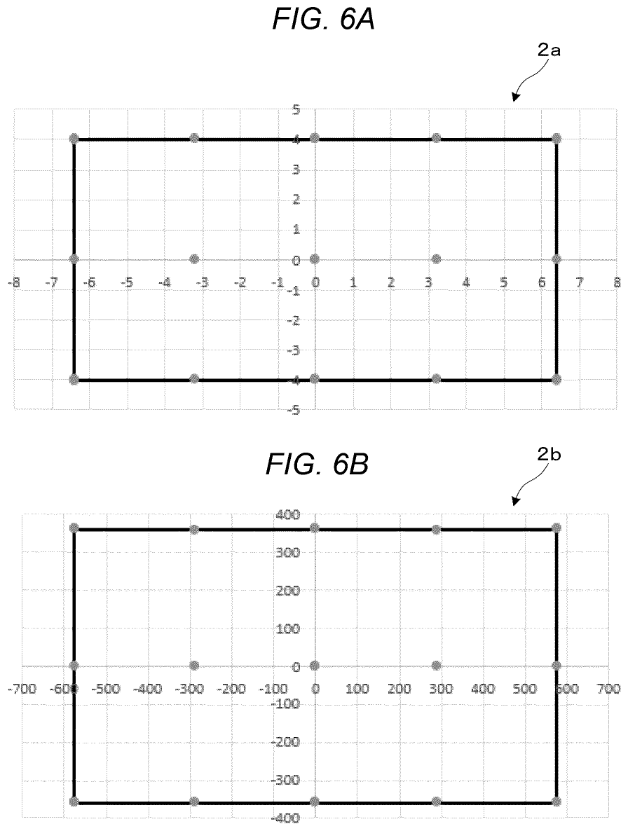

FIGS. 4 and 5 show lateral aberration characteristics of the optical device 50 or the projection optical system 40 in Example 1. FIG. 6 shows a relationship between the display surface 2a of the liquid crystal panel 29G and the projection surface 2b of the screen SC in Example 1. In an upper part in FIG. 6, each black circle indicates a light ray position on the display surface 2a, and in a lower part in FIG. 6, each black circle indicates a light ray position on the projection surface 2b. Coordinates shown in FIG. 6 are based on a center of the display surface 2a or a center of the projection surface 2b. Since light ray positions are left-right symmetric, the lateral aberration diagrams show characteristics of nine points on one side corresponding to the coordinates on the display surface 2a.

### Example 2

Table 5 shows data of optical surfaces in Example 2. Terms in Table 5 are shown below.
OM1=SBSL7_OHARA
OM3=Z-330R
OM4=refractive index; 1.611082, Abbe number; 60.81

TABLE 5

| SuNo | SuTy | R | D | Mt | SuFu | Ar |
|---|---|---|---|---|---|---|
| 1 | SP | INF | 9.5000 | | DK | 7.5472 |
| 2 | SP | INF | 3.9100 | OM1 | DK | 9.2365 |
| 3 | SP | INF | 7.2846 | | DK | 9.7044 |
| 4 | NP | 49.8097 | 13.8882 | OM4 | DK | 11.2471 |
| 5 | NP | 186.2120 | 0.2693 | | DK | 12.2243 |
| 6 | SP | INF | T-C | | DK | 12.6232 |
| 7 | NE | −84.9608 | T-C | OM3 | DK | 50.8200 |
| 8 | NP | −112.7171 | T-C | OM3 | RH | 23.8643 |
| 9 | NP | −84.9608 | T-C | | DK | 55.6188 |
| 10 | XY-FS | −93.9326 | T-C | | RH | 29.7172 |
| 11 | XY-FS | 117.2187 | T-C | | RH | 70.3931 |
| 12 | XY-FS | 293.0086 | T-C | | RH | 58.3479 |
| 13 | NP | 41.8414 | T-C | OM3 | DK | 40.9551 |
| 14 | NP | −63.7839 | T-C | OM3 | RH | 25.6467 |
| 15 | NP | 25.0533 | T-C | | DK | 24.5783 |
| 16 | SP | INF | T-C | | DK | 112.6470 |
| 17 | SP | INF | −608.6860 | | DK | 112.6470 |
| 18 | SP | INF | 0.0000 | | DK | 998.6492 |

Table 6 shows an eccentricity setting of Example 2.

TABLE 6

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | N/A | — | — | — | — |
| 5 | N/A | — | — | — | — |
| 6 | dc & re | — | — | 3.0000 | — |
| 7 | dc & re | — | −33.0678 | 33.2334 | −40.1130 |
| 8 | dc & re | — | −4.4842 | 80.0000 | −11.9911 |
| 9 | dc & re | — | −33.0678 | 33.2334 | −40.1130 |
| 10 | dc & re | — | 41.1897 | 3.2922 | 13.4349 |
| 11 | dc & re | — | −3.7472 | 63.0118 | 21.2169 |
| 12 | dc & re | — | 80.5829 | 0.0000 | −5.2742 |
| 13 | dc & re | — | 100.0140 | 33.8904 | 1.6073 |
| 14 | dc & re | — | 100.0140 | 80.0000 | 1.6073 |
| 15 | dc & re | — | 100.0140 | 33.8904 | 1.6073 |
| 16 | nr | — | — | 80.0000 | — |

Table 7 shows aspherical surface data in Example 2. Terms in Table 7 are shown below.
A: fourth-order aspherical coefficient
B: sixth-order aspherical coefficient
C: eighth-order aspherical coefficient
D: tenth-order aspherical coefficient

TABLE 7

| SuNo | 4 | 5 | 7 | 8 | 9 | 13 | 14 | 15 |
|---|---|---|---|---|---|---|---|---|
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | 0 | 0 | 0 | 0 | 0 | 0 | 0 | 0 |

[symbol]

indicates data missing or illegible when filed

Table 8 shows XY polynomial surface data in Example 2.

TABLE 8

| SuNo | 10 | 11 | 12 |
|---|---|---|---|
| R | −93.9326 | 117.2187 | 293.0086 |
| k | 1.9859 | 0.6469 | 16.8007 |
| C-x4 | 6.53103E−08 | 1.09638E−06 | 1.04175E+01 |
| C-x2y2 | 5.71313E−07 | −2.40626E−06 | 1.83087E+01 |
| C-y4 | 1.29657E−07 | −2.69558E−07 | 7.83848E+00 |
| C-x6 | 7.74963E−10 | −3.61753E−10 | −1.02890E+01 |
| C-x4y2 | 6.75931E−10 | 1.33428E−10 | −2.47269E+01 |
| C-x2y4 | 4.52403E−10 | 5.68416E−10 | −2.43574E+01 |
| C-y6 | 1.83534E−10 | −8.33877E−11 | −6.86895E+00 |
| C-x8 | 4.1171E−13 | −6.84598E−13 | 6.67097E+00 |
| C-x6y2 | −1.77552E−12 | 1.12529E−13 | 2.55089E+01 |
| C-x4y4 | −3.63489E−13 | −7.89182E−14 | 3.24116E+01 |
| C-x2y6 | −2.86622E−13 | −5.69916E−14 | 2.12806E+01 |
| C-y8 | −6.30432E−14 | 1.76237E−14 | 3.70168E+00 |
| C-x10 | | 1.81249E−15 | 7.98339E−01 |
| C-x8y2 | | −9.71719E−17 | −1.53734E+01 |
| C-x6y4 | | 2.86831E−17 | −2.31288E+01 |
| C-x4y6 | | 6.21622E−18 | −2.05257E+01 |
| C-x2y8 | | 1.53622E−18 | −1.08005E+01 |
| C-y10 | | −1.29043E−18 | −1.36452E+00 |

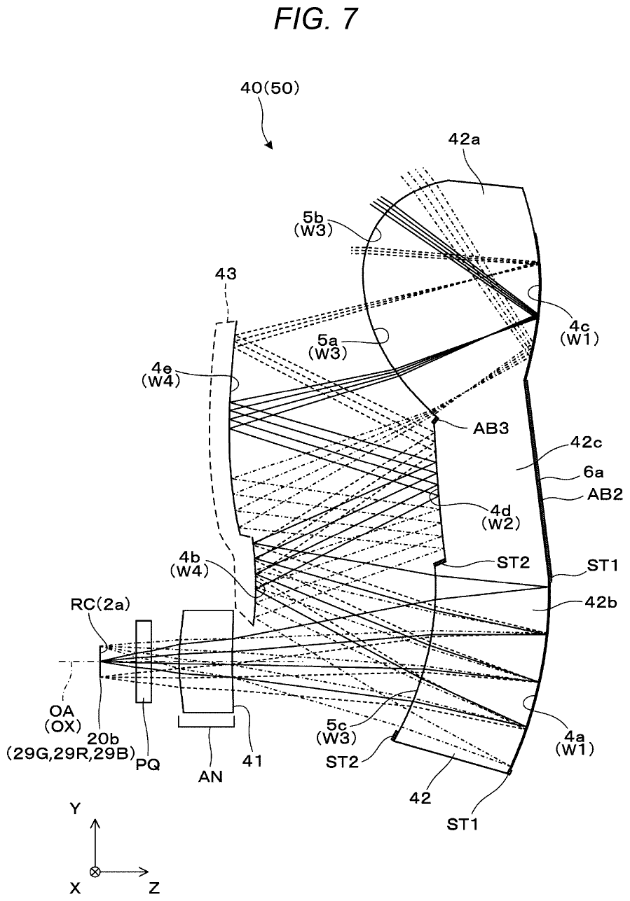

FIG. 7 is a cross-sectional view of the optical device 50 in Example 2.

The optical device 50 includes a polarization member PQ, the lens 41, the first internal reflection element 42, and the mirror element 43. In Example 2, the polarization member PQ including a polarizing plate and a holding substrate for the polarizing plate is provided instead of the prism PR. The first internal reflection element 42 is formed by integrating the first optical element 42a, the second optical element 42b, and the third optical element 42c. The third optical element 42c is disposed between the first optical element 42a and the second optical element 42b. The mirror element 43 faces the first internal reflection element 42.

The first optical element 42a has the first transmissive surface 5a, the third reflective surface 4c, and the second transmissive surface 5b. The third reflective surface 4c is the concave internal reflective surface W1. In the first optical element 42a, the refractive surface W3 through which incident light and reflected light pass is different between the first transmissive surface 5a and the second transmissive surface 5b. The first transmissive surface 5a, the third reflective surface 4c, and the second transmissive surface 5b each have a positive power.

The second optical element 42b has the first reflective surface 4a and the third transmissive surface 5c. The first reflective surface 4a is the concave internal reflective surface W1. In the second optical element 42b, the refractive surface W3 through which incident light and reflected light pass is common to the third transmissive surface 5c. The first aperture stop ST1 is disposed at the first reflective surface 4a. The second aperture stop ST2 is disposed at the third transmissive surface 5c.

The third optical element 42c has the fourth reflective surface 4d that is the surface reflective surface W2. The second light-absorbing member AB2 is disposed at the back surface 6a that is the surface opposite to the fourth reflective surface 4d.

The mirror element 43 has the second reflective surface 4b that is the surface reflective surface W4 and the fifth reflective surface 4e that is the surface reflective surface W4. The second and fifth reflective surfaces 4b and 4e are integrated.

The optical device 50 has the third transmissive surface 5c, the first reflective surface 4a, the third transmissive surface 5c, the second reflective surface 4b, the fourth reflective surface 4d, the fifth reflective surface 4e, the first transmissive surface 5a, the third reflective surface 4c, and the second transmissive surface 5b in order from the reduction side to the magnification side on the optical path. The third transmissive surface 5c, the fourth reflective surface 4d, the first transmissive surface 5a, and the second transmissive surface 5b are disposed on the second reflective surface 4b side. The second light-absorbing member AB2 and the third reflective surface 4c are disposed on the first reflective surface 4a side.

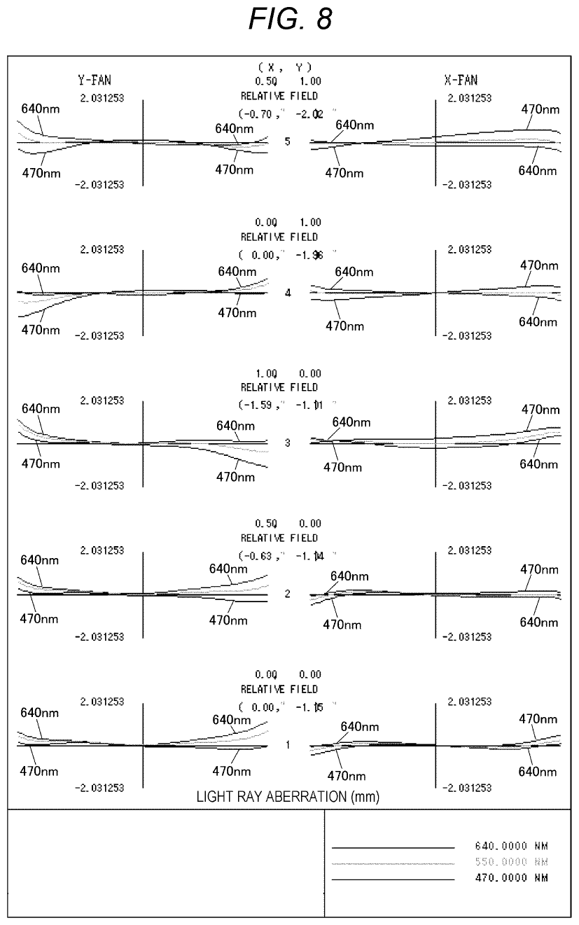

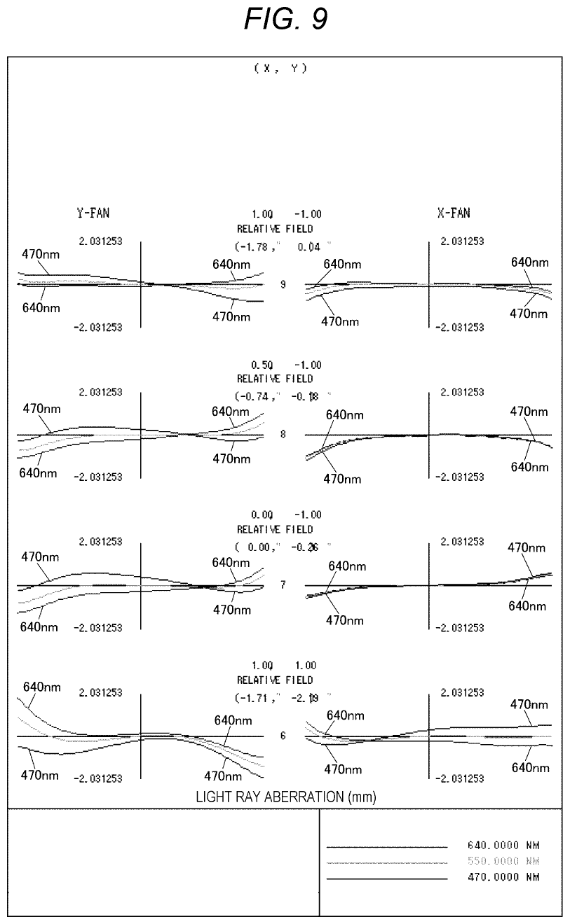

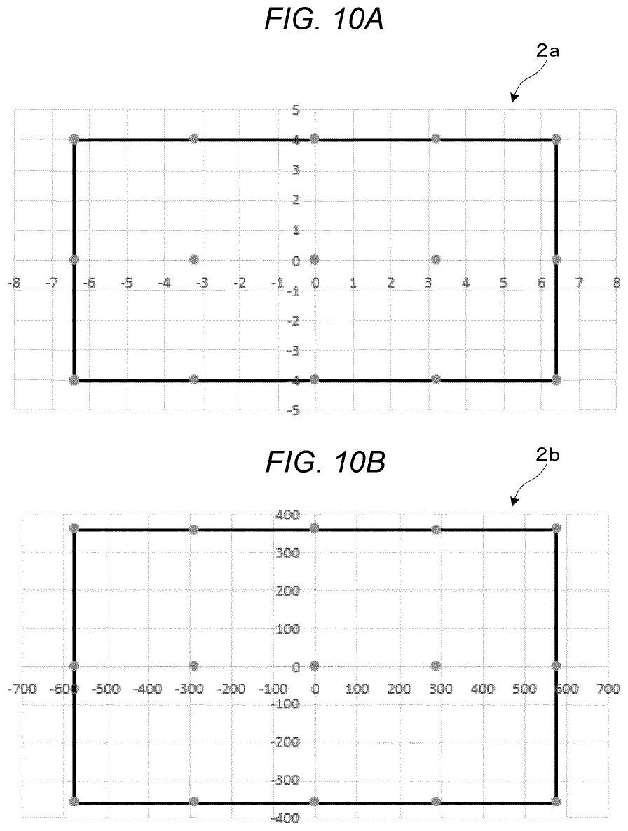

FIGS. 8 and 9 show lateral aberration characteristics of the optical device 50 or the projection optical system 40 in Example 2. FIG. 10 shows a relationship between the display surface 2a of the liquid crystal panel 29G and the projection surface 2b of the screen SC in Example 2.

### Second Embodiment

Hereinafter, an optical device and the like according to a second embodiment will be described. The optical device according to the second embodiment is obtained by partially changing the optical device according to the first embodiment, and descriptions of portions common to the optical device according to the first embodiment will be omitted.

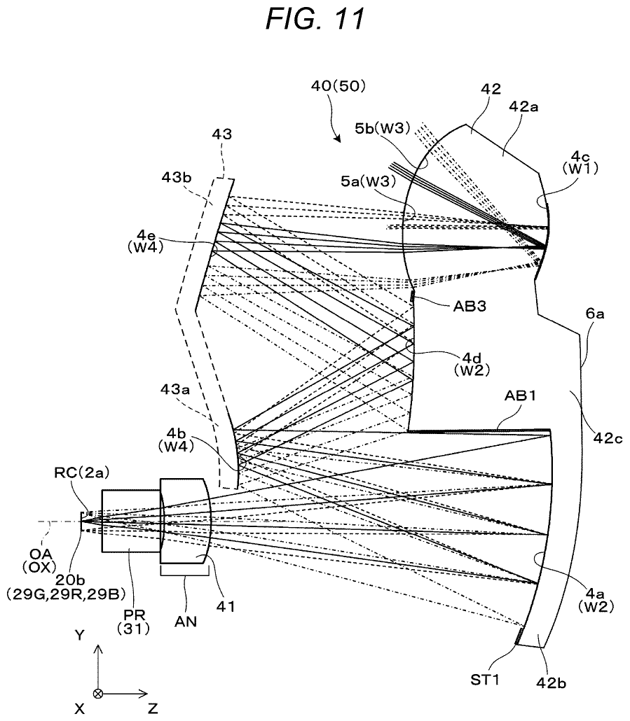

FIG. 11 shows a configuration and a light ray diagram of the optical device 50. The optical device 50 shown as an example in FIG. 11 has the same configuration as the optical device 50 in Example 3 to be described later. In FIG. 11, there are light rays deviated from the second transmissive surface 5b among light rays emitted from the first optical element 42a to the screen SC (see FIG. 2), but in practice, such light rays are prevented from exiting by adjusting the display surface 2a.

The first internal reflection element 42 includes the first optical element 42a, the second optical element 42b, and the third optical element 42c. In the embodiment, the second optical element 42b has the first reflective surface 4a that is the surface reflective surface W2. The first aperture stop ST1 is disposed at the first reflective surface 4a.

In the example in FIG. 11, the mirror element 43 is a member where the second reflective surface 4b and the fifth reflective surface 4e are integrated, and alternatively, the surfaces may be separate. Specifically, in the mirror element 43, a first mirror member 43a having the second reflective surface 4b and a second mirror member 43b having the fifth reflective surface 4e may be formed separately. In this case, a position of the second reflective surface 4b and a position of the fifth reflective surface 4e can be individually adjusted.

The optical device 50 includes a first light-absorbing member AB1 that is disposed spatially between the first reflective surface 4a and the third reflective surface 4c in the third optical element 42c, specifically, disposed to lie along a step. The first light-absorbing member AB1 prevents light reflected by the first reflective surface 4a and light reflected by the second reflective surface 4b from leaking to an unintended optical path and returning to an intended optical path from another location. That is, the first light-absorbing member AB1 prevents the reflected light from leaking to the unintended optical path and propagating through an inner surface of the first internal reflection element 42 or the like. Accordingly, it is possible to shield unnecessary light that is reflected by the first reflective surface 4a and the second reflective surface 4b in the vicinity, peripheries thereof, and the like and causes stray light. Examples of a material of the first light-absorbing member AB1 include a paint or another substance having light-absorbing properties, and a light-shielding film.

In the third optical element 42c, the second light-absorbing member AB2 may be disposed at the back surface 6a, which is the surface opposite to the fourth reflective surface 4d.

### Example 3

Table 9 shows optical surface data in Example 3. Terms in Table 9 are shown below.
OM1=SBSL7_OHARA
OM5=refractive index; 1.743972, Abbe number; 44.85

TABLE 9

| SuNo | SuTy | R | D | Mt | SuFu | Ar |
|---|---|---|---|---|---|---|
| 1 | SP | INF | 9.5000 | | DK | 7.5472 |
| 2 | SP | INF | 25.9100 | OM1 | DK | 9.2843 |
| 3 | SP | INF | 1.7004 | | DK | 12.5340 |
| 4 | NP | −60.4134 | 20.7975 | OM1 | DK | 12.5345 |
| 5 | NP | −60.4209 | 0.1000 | | DK | 17.3818 |
| 6 | SP | INF | T-C | | DK | 20.0210 |
| 7 | SP | INF | T-C | | DK | 24.0000 |
| 8 | NP | −194.9391 | T-C | | RH | 42.6353 |
| 9 | NP | −75.0088 | T-C | | RH | 23.7386 |
| 10 | NP | −245.4417 | T-C | | RH | 148.1425 |
| 11 | NP | 912.8235 | T-C | | RH | 57.3752 |
| 12 | NP | 69.9845 | T-C | OM5 | DK | 35.8677 |
| 13 | NP | −41.5077 | T-C | OM5 | RH | 22.3285 |
| 14 | NP | 69.9845 | T-C | | DK | 44.7275 |
| 15 | SP | INF | T-C | | DK | 140.6851 |
| 16 | SP | INF | −608.6860 | | DK | 140.6851 |
| 17 | SP | INF | 0.0000 | | DK | 1022.9551 |

Table 10 shows an eccentricity setting of Example 3.

TABLE 10

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | N/A | — | — | — | — |
| 5 | N/A | — | — | — | — |
| 6 | nr | — | −5.6670 | — | — |
| 7 | dc & re | — | — | 3.0000 | — |
| 8 | dc & re | — | 0.8199 | 150.0000 | −7.8344 |
| 9 | dc & re | — | 45.1103 | 10.0000 | 13.4408 |
| 10 | dc & re | — | −42.4005 | 60.0000 | −27.9448 |
| 11 | dc & re | — | 155.8381 | 10.0000 | −18.4113 |
| 12 | dc & re | — | 135.3735 | 85.2273 | −2.4034 |
| 13 | dc & re | — | 135.3735 | 150.0000 | −2.4034 |
| 14 | dc & re | — | 135.3735 | 85.2273 | −2.4034 |
| 15 | nr | — | — | 150.0000 | — |

Table 11 shows aspherical surface data in Example 3.

TABLE 11

| SuNo | 4 | 5 | 8 | 9 | 10 | 11 | 12 | 13 | 14 |
|---|---|---|---|---|---|---|---|---|---|
| [symbol] | [symbol] | [symbol] | [symbol] | [symbol] | [symbol] | [symbol] | [symbol] | [symbol] | [symbol] |
| [symbol] | 0 | 0 | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | 0 | 0 | 0 | 0 | [symbol] | [symbol] | 0 | 0 | 0 |

[symbol]

indicates data missing or illegible when filed

FIG. 11 is a cross-sectional view of the optical device 50 in Example 3.

The optical device 50 includes the prism PR, the lens 41, the first internal reflection element 42, and the mirror element 43. The first internal reflection element 42 is formed by integrating the first optical element 42a, the second optical element 42b, and the third optical element 42c. The third optical element 42c is disposed between the first optical element 42a and the second optical element 42b. The mirror element 43 faces the first internal reflection element 42.

The first optical element 42a has the first transmissive surface 5a, the third reflective surface 4c, and the second transmissive surface 5b. The third reflective surface 4c is the concave internal reflective surface W1. In the first optical element 42a, the refractive surface W3 through which incident light and reflected light pass is different between the first transmissive surface 5a and the second transmissive surface 5b. The first transmissive surface 5a, the third reflective surface 4c, and the second transmissive surface 5b each have a positive power.

The second optical element 42b has the first reflective surface 4a. The first reflective surface 4a is the concave surface reflective surface W2. The first aperture stop ST1 is disposed at the first reflective surface 4a.

The third optical element 42c has the fourth reflective surface 4d that is the surface reflective surface W2. Between the first reflective surface 4a and the third reflective surface 4c, the first light-absorbing member AB1 is disposed to lie along a step spatially.

The mirror element 43 has the second reflective surface 4b that is the surface reflective surface W4 and the fifth reflective surface 4e that is the surface reflective surface W4.

The optical device 50 has the first reflective surface 4a, the second reflective surface 4b, the fourth reflective surface 4d, the fifth reflective surface 4e, the first transmissive surface 5a, the third reflective surface 4c, and the second transmissive surface 5b in order from the reduction side to the magnification side on the optical path. The fourth reflective surface 4d, the first transmissive surface 5a, and the second transmissive surface 5b are disposed on the first reflective surface 4a side. The third reflective surface 4c is disposed on a side opposite to the first reflective surface 4a.

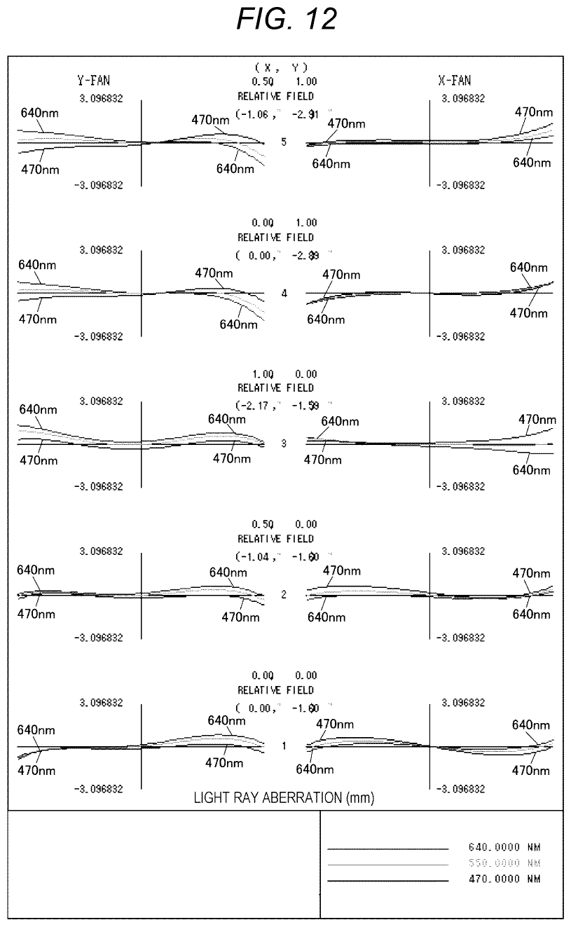

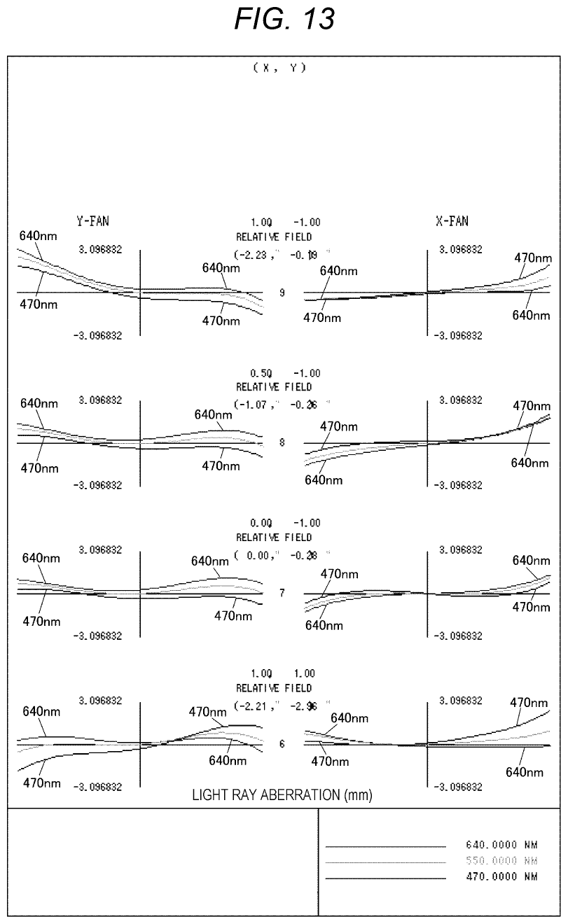

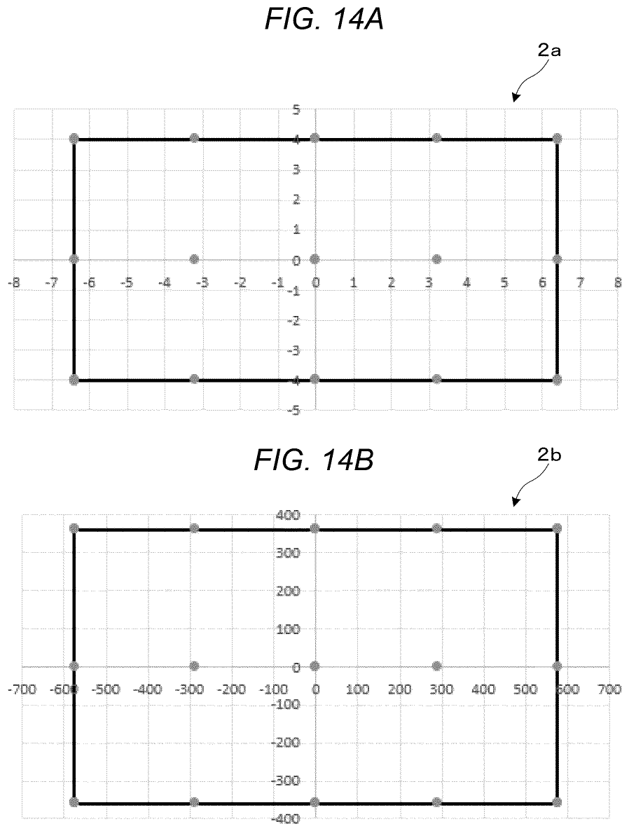

FIGS. 12 and 13 show lateral aberration characteristics of the optical device 50 or the projection optical system 40 in Example 3. FIG. 14 shows a relationship between the display surface 2a of the liquid crystal panel 29G and the projection surface 2b of the screen SC in Example 3.

### Third Embodiment

Hereinafter, an optical device and the like according to a third embodiment will be described. The optical device according to the third embodiment is obtained by partially changing the optical device according to the first embodiment, and descriptions of portions common to the optical device according to the first embodiment will be omitted.

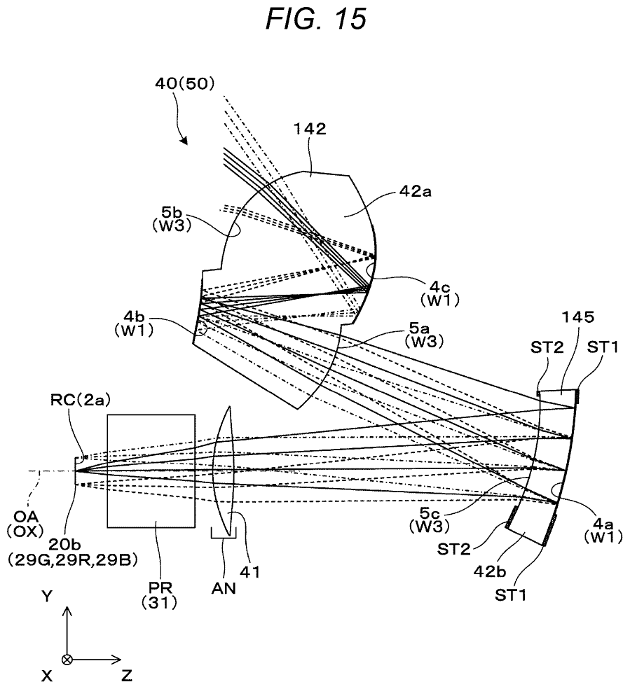

FIG. 15 shows a configuration and a light ray diagram of the optical device 50. The optical device 50 shown as an example in FIG. 15 has the same configuration as the optical device 50 in Example 4 to be described later.

As shown in FIG. 15, in the embodiment, the optical device 50 includes a first internal reflection element 142 corresponding to the first optical element 42a and a second internal reflection element 145 corresponding to the second optical element 42b. That is, the first optical element 42a and the second optical element 42b are separate internal reflection elements spaced apart from each other. The optical device 50 does not include the mirror element 43 shown in FIG. 3 and the like. The second reflective surface 4b is provided in the first internal reflection element 142 as the internal reflective surface W1.

The second optical element 42b has the first reflective surface 4a and the third transmissive surface 5c. The first optical element 42a has the first transmissive surface 5a, the second reflective surface 4b, the third reflective surface 4c, and the second transmissive surface 5b. The second reflective surface 4b is disposed between the first transmissive surface 5a and the third reflective surface 4c on the optical path. The first optical element 42a has two internal reflective surfaces W1 and two refractive surfaces W3, thus it is possible to reduce the number of components and to reduce a size of the first optical element 42a while ensuring assembly accuracy.

In the above description, focusing on the optical surfaces of the first internal reflection element 142, the optical device 50 has the third transmissive surface 5c, the first reflective surface 4a, the third transmissive surface 5c, the second reflective surface 4b, the first transmissive surface 5a, the third reflective surface 4c, and the second transmissive surface 5b in order from the reduction side to the magnification side on the optical path. In the optical device 50, image light is reflected three times.

Focusing on the optical surfaces of the first internal reflection element 142 in a cross-sectional view, the second transmissive surface 5b is disposed on the second reflective surface 4b side. The first transmissive surface 5a and the third reflective surface 4c are disposed on the first reflective surface 4a side.

Focusing on the optical surfaces of the second internal reflection element 145 in a cross-sectional view, the third transmissive surface 5c is disposed on the second reflective surface 4b side. The first reflective surface 4a is disposed on a side opposite to the third transmissive surface 5c.

In the embodiment, the second internal reflection element 145 may be omitted. In this case, the first reflective surface 4a, which is the surface reflective surface W2, is provided in the light transmissive member or the mirror element.

### Example 4

Table 12 shows optical surface data in Example 4. Terms in Table 12 are shown below.
OM1=SBSL7_OHARA
OM3=Z-330R
OM6=refractive index; 1.487490, Abbe number; 70.41

TABLE 12

| SuNo | SuTy | R | D | Mt | SuFu | Ar |
|---|---|---|---|---|---|---|
| 1 | SP | INF | 9.5000 | | DK | 7.5472 |
| 2 | SP | INF | 25.9100 | OM1 | DK | 10.1784 |
| 3 | SE | INF | 2.0000 | | DK | 14.9358 |
| 4 | SP | INF | 3.2700 | | DK | 15.5126 |
| 5 | NP | 36.0638 | 6.2541 | OM6 | DK | 17.6689 |
| 6 | NP | −103.2311 | 0.1000 | | DK | 17.6875 |
| 7 | SE | INF | T-C | | DK | 17.6819 |
| 8 | XY-FS | −75.9234 | T-C | OM3 | DK | 62.8031 |
| 9 | NP | −129.8768 | T-C | OM3 | RH | 18.8980 |
| 10 | XY-FS | −75.9234 | T-C | | DK | 64.2051 |
| 11 | XY-FS | −34.3395 | T-C | OM3 | DK | 30.2612 |
| 12 | XY-FS | −69.1500 | T-C | OM3 | RH | 28.3192 |
| 13 | XY-FS | −28.2357 | T-C | OM3 | RH | 22.5869 |
| 14 | XY-FS | 42.8682 | T-C | | DK | 26.4600 |
| 15 | SP | INF | T-C | | DK | 117.5476 |
| 16 | SP | INF | −428.0000 | | DK | 117.5476 |
| 17 | SE | INF | 0.0000 | | DK | 844.3464 |

Table 13 shows an eccentricity setting of Example 4.

TABLE 13

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | nr | — | — | — | — |
| 5 | N/A | — | — | — | — |
| 6 | N/A | — | — | — | — |
| 7 | dc & re | — | — | 3.0000 | — |
| 8 | dc & re | — | −43.6365 | 54.4719 | −59.1523 |
| 9 | dc & re | — | — | 98.0614 | −12.5052 |
| 10 | dc & re | — | −43.6365 | 54.4719 | −59.1523 |
| 11 | dc & re | — | 50.5882 | 31.3508 | 8.7435 |
| 12 | dc & re | — | 67.4068 | −9.8900 | 7.5044 |
| 13 | dc & re | — | 65.5141 | 41.7329 | 0.9135 |
| 14 | dc & re | — | 65.5141 | −3.0000 | −13.1027 |
| 15 | nr | — | — | −3.0000 | — |
| 16 | dc & re | — | — | — | — |
| 17 | N/A | — | — | — | — |

Table 14 shows aspherical surface data in Example 4.

TABLE 14
SuNo 5

| SuNo | 5 | 6 | 9 |
|---|---|---|---|
| R | 36.0638 | −103.2311 | −129.8768 |
| k | 0 | 0 | −0.204334463 |
| A | −5.53175E−06 | 4.03967E−06 | −3.09511E−08 |
| B | 3.19445E−09 | 1.01016E−09 | 1.76096E−11 |
| C | 1.77458E−13 | 3.22957E−12 | 4.46445E−15 |

Table 15 shows XY polynomial surface data in Example 4.

TABLE 15

| SuNo | 8 | 10 | 11 | 12 | 13 | 14 |
|---|---|---|---|---|---|---|
| R | −75.92341209 | −75.92341209 | −34.3395132 | −69.15001005 | −28.23568973 | 42.86818299 |
| k | 7.37E−02 | 7.37E−02 | −7.48E−01 | 0.00E+00 | −9.68E−01 | 0.00E+00 |
| C-x4 | −2.92398E−08 | −2.92398E−08 | −2.44234E−06 | 3.02595E−06 | 1.99290E−06 | 1.41834E−06 |
| C- | 9.40436E−08 | 9.40436E−08 | −5.62026E−06 | −2.6099E−06 | 8.98387E−06 | 1.04502E−05 |
| x2y2 | | | | | | |
| C-y4 | −1.16367E−07 | −1.16367E−07 | −2.74641E−06 | −1.94533E−06 | 9.11068E−06 | 1.65565E−05 |
| C-x6 | −1.10503E−11 | −1.10503E−11 | −1.1951E−09 | −1.71561E−08 | 2.16544E−09 | 1.0788E−08 |
| C- | −2.81184E−11 | −2.81184E−11 | −1.58686E−09 | 9.98962E−09 | −2.05594E−09 | −9.74309E−10 |
| x4y2 | | | | | | |
| C- | 3.49827E−11 | 3.49827E−11 | −2.36937E−09 | 1.43307E−08 | −1.16029E−08 | −2.11876E−08 |
| x2y4 | | | | | | |
| C-y6 | 2.49389E−11 | 2.49389E−11 | −1.02607E−09 | 4.01884E−09 | −1.15044E−08 | −2.43698E−08 |
| C-x8 | 6.49862E−15 | 6.49862E−15 | −9.59332E−13 | 3.63666E−11 | −5.0851E−12 | −1.55177E−11 |
| C- | 1.06525E−15 | 1.06525E−15 | −4.19086E−12 | 1.00581E−11 | 1.5665E−12 | 1.46506E−11 |
| x6y2 | | | | | | |
| C- | −5.031E−15 | −5.031E−15 | −5.04393E−12 | −1.07969E−11 | 3.85368E−12 | 5.02038E−11 |
| x4y4 | | | | | | |
| C- | −5.66812E−15 | −5.66812E−15 | −3.13576E−12 | −6.86295E−12 | 1.08605E−11 | 4.95155E−11 |
| x2y6 | | | | | | |
| C-y8 | −1.22005E−15 | −1.22005E−15 | −9.18268E−13 | −1.31198E−12 | 7.79321E−12 | 2.27752E−11 |

FIG. 15 is a cross-sectional view of the optical device 50 in Example 4.

The optical device 50 includes the prism PR, the lens 41, the first internal reflection element 142, and the second internal reflection element 145. The first optical element 42a of the first internal reflection element 142 and the second optical element 42b of the second internal reflection element 145 are separate.

The first optical element 42a has the first transmissive surface 5a, the second reflective surface 4b, the third reflective surface 4c, and the second transmissive surface 5b. The second reflective surface 4b is the convex internal reflective surface W1. The third reflective surface 4c is the concave internal reflective surface W1. In the first optical element 42a, the refractive surface W3 through which incident light and reflected light pass is different between the first transmissive surface 5a and the second transmissive surface 5b. The first transmissive surface 5a, the third reflective surface 4c, and the second transmissive surface 5b each have a positive power.

The second optical element 42b has the first reflective surface 4a and the third transmissive surface 5c. The first reflective surface 4a is the concave internal reflective surface W1. In the second optical element 42b, the refractive surface W3 through which incident light and reflected light pass is common to the third transmissive surface 5c. The first aperture stop ST1 is disposed at the first reflective surface 4a. The second aperture stop ST2 is disposed at the third transmissive surface 5c.

The optical device 50 has the third transmissive surface 5c, the first reflective surface 4a, the third transmissive surface 5c, the first transmissive surface 5a, the second reflective surface 4b, the third reflective surface 4c, and the second transmissive surface 5b in order from the reduction side to the magnification side on the optical path.

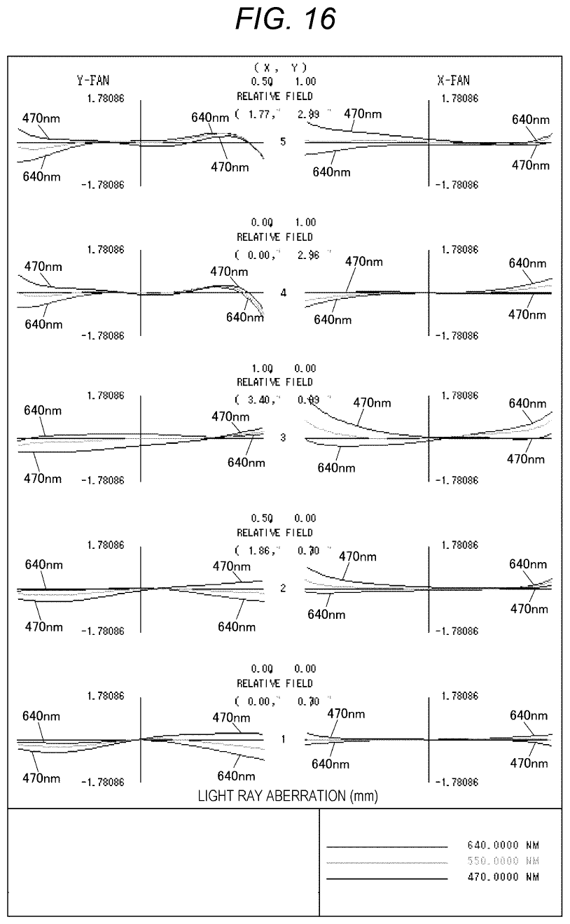

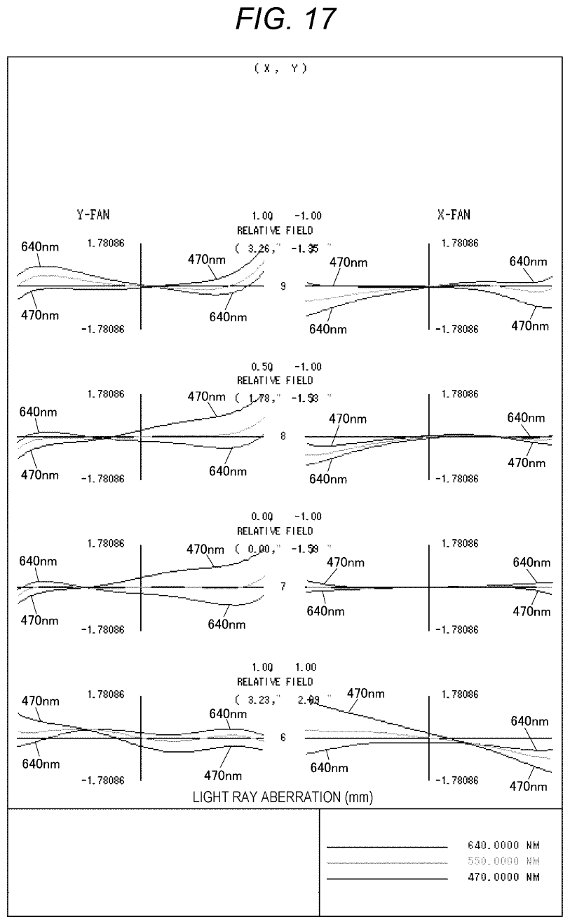

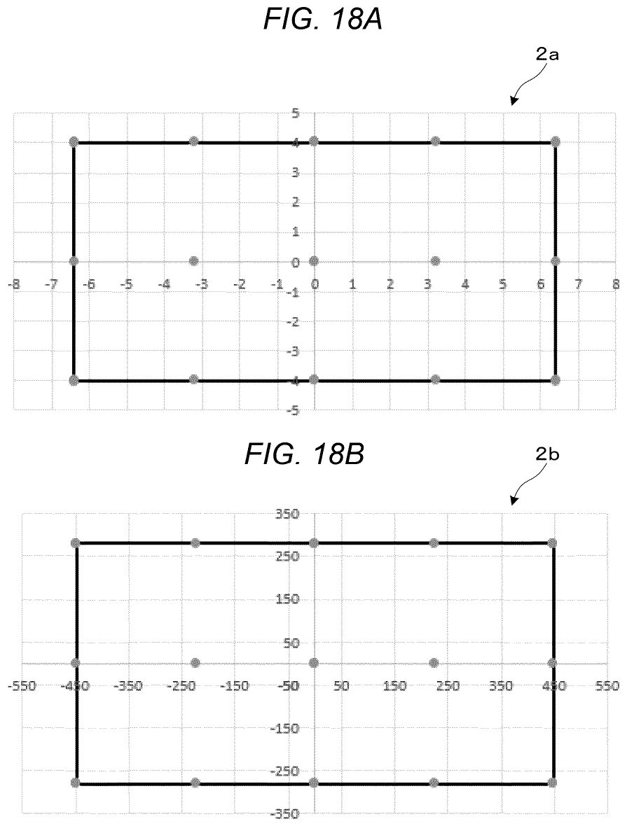

FIGS. 16 and 17 show lateral aberration characteristics of the optical device 50 or the projection optical system 40 in Example 4. FIG. 18 shows a relationship between the display surface 2a of the liquid crystal panel 29G and the projection surface 2b of the screen SC in Example 4.

### Fourth Embodiment

Hereinafter, an optical device and the like according to a fourth embodiment will be described. The optical device according to the fourth embodiment is obtained by partially changing the optical device according to the first embodiment, and descriptions of portions common to the optical device according to the first embodiment will be omitted.

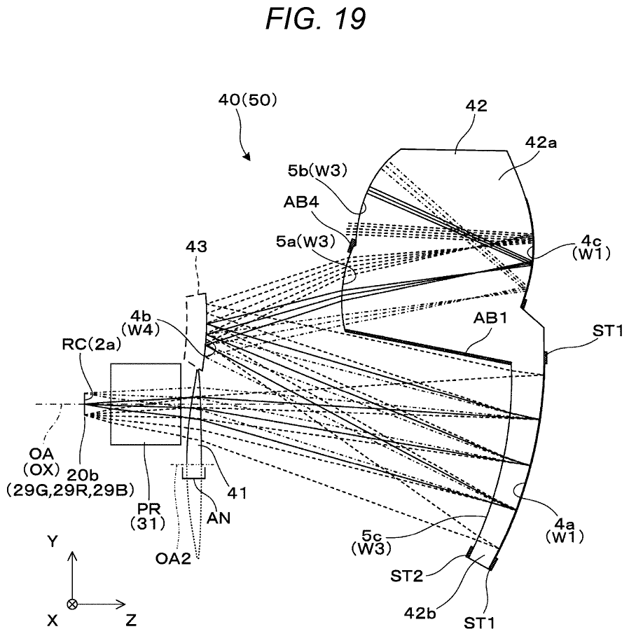

FIG. 19 shows a configuration and a light ray diagram of the optical device 50. The optical device 50 shown as an example in FIG. 19 has the same configuration as the optical device 50 in Example 5 to be described later.

As shown in FIG. 19, in the embodiment, the mirror element 43 has the second reflective surface 4b as one surface reflective surface W4. The optical device 50 does not include the third optical element 42c shown in FIG. 3 and the like. As will be described in detail later, the lens 41 is eccentric. Since the lens 41 is eccentric, in the example in FIG. 19, the lens 41 has a shape of only an upper half of a circular lens shape where a light ray is incident.

The first internal reflection element 42 includes the first optical element 42a and the second optical element 42b.

The first optical element 42a has the first transmissive surface 5a, the third reflective surface 4c that is the internal reflective surface W1, and the second transmissive surface 5b. The second optical element 42b has the first reflective surface 4a that is the internal reflective surface W1, and the third transmissive surface 5c. The first aperture stop ST1 is disposed at the first reflective surface 4a. The second aperture stop ST2 is disposed at the third transmissive surface 5c.

The optical device 50 includes the first light-absorbing member AB1 that is disposed spatially between the first reflective surface 4a and the third reflective surface 4c in the first optical element 42a, specifically, disposed to lie along a step. The first light-absorbing member AB1 prevents light reflected by the first reflective surface 4a and light reflected by the third reflective surface 4c from leaking to an unintended optical path and returning to an intended optical path from another location. Accordingly, it is possible to shield unnecessary light that is reflected by the first reflective surface 4a and the third reflective surface 4c in the vicinity, peripheries thereof, and the like and causes stray light.

As shown in FIG. 19, at the boundary between the first transmissive surface 5a and the second transmissive surface 5b, the fourth light-absorbing member AB4 may be provided to prevent incident light onto the first optical element 42a or reflected light from leaking to an unintended optical path and returning to an intended optical path from another location.

Since the mirror element 43 includes only the second reflective surface 4b, a size thereof can be reduced.

The lens optical axis OA2 of the lens 41 is shifted to a side opposite to the magnification-side conjugate surface MC (see FIG. 2) corresponding to the screen SC relative to a center of the display device (specifically, the liquid crystal panel 29G or the like), the display surface 2a, or the reduction-side conjugate surface RC. The lens optical axis OA2 is defined by an axis connecting centers of curvature of an incident surface and an exit surface of the lens 41. In other words, the lens 41 is shifted downward, that is, in a-Y direction in a vertical direction that is the Y direction perpendicular to the central axis Ox passing through a center of the reduction-side conjugate surface RC or a reduction-side imaging surface. Accordingly, a position of the first reflective surface 4a relative to the central axis OX of the reduction-side conjugate surface RC can be disposed spatially on a lower side opposite to the magnification-side conjugate surface MC or a magnification-side imaging surface, and thus a height of the optical system disposed above the first reflective surface 4a can be reduced.

In the above description, focusing on the optical surfaces of the first internal reflection element 42, the optical device 50 has the third transmissive surface 5c, the first reflective surface 4a, the third transmissive surface 5c, the second reflective surface 4b, the first transmissive surface 5a, the third reflective surface 4c, and the second transmissive surface 5b in order from the reduction side to the magnification side on the optical path. In the optical device 50, image light is reflected three times.

The first reflective surface 4a may be the surface reflective surface W2, and in this case, the third transmissive surface 5c is omitted.

### Example 5

Table 16 shows optical surface data in Example 5. Terms in Table 16 are shown below.
OM1=SBSL7_OHARA
OM3=Z-330R
OM7=refractive index; 1.726214, Abbe number; 46.31

TABLE 16

| SuNo | SuTy | R | D | Mt | SuFu | Ar |
|---|---|---|---|---|---|---|
| 1 | SP | INF | 9.5000 | | DK | 7.5472 |
| 2 | SP | INF | 25.9100 | OM1 | DK | 9.7451 |
| 3 | SP | INF | 2.0000 | | DK | 13.7613 |
| 4 | SP | INF | 0.1000 | | DK | 32.1848 |
| 5 | NP | 139.5526 | 5.4309 | OM7 | DK | 32.8822 |
| 6 | NP | −708.9518 | 0.1000 | | DK | 32.9198 |
| 7 | SP | INF | T-C | | DK | 32.8981 |
| 8 | XY-FS | −149.8539 | T-C | OM3 | DK | 63.7420 |
| 9 | NP | −160.3254 | T-C | OM3 | RH | 33.0160 |
| 10 | XY-FS | −149.8539 | T-C | | DK | 65.2283 |
| 11 | XY-FS | −87.8103 | T-C | | RH | 36.6254 |
| 12 | NP | 44.7074 | T-C | OM3 | DK | 32.6154 |
| 13 | NP | −51.1453 | T-C | OM3 | RH | 23.5107 |
| 14 | NP | 67.4623 | T-C | | DK | 33.0498 |
| 15 | SP | INF | T-C | | DK | 125.4074 |
| 16 | SP | INF | −428.0000 | | DK | 125.4074 |
| 17 | SP | INF | 0.0000 | | DK | 586.7627 |

Table 17 shows an eccentricity setting of Example 5.

TABLE 17

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | nr | — | −22.0248 | — | — |
| 5 | N/A | — | — | — | — |
| 6 | N/A | — | — | — | — |
| 7 | dc & re | — | — | 3.0000 | — |
| 8 | dc & re | — | −31.0889 | 100.0000 | −25.3615 |
| 9 | dc & re | — | — | 121.1061 | −14.3469 |
| 10 | dc & re | — | −31.0889 | 100.0000 | −25.3615 |
| 11 | dc & re | — | 72.7328 | 0.0000 | 11.4997 |
| 12 | dc & re | — | 82.0498 | 56.8527 | −27.1342 |
| 13 | dc & re | — | 80.9973 | 122.1011 | 0.5979 |
| 14 | dc & re | — | 82.0498 | 56.8527 | −3.9475 |
| 15 | nr | — | — | 56.8527 | — |
| 16 | dc & re | — | — | — | — |
| 17 | N/A | — | — | — | — |

Table 18 shows aspherical surface data in Example 5.

TABLE 18

| SuNo | 5 | 6 | 9 | 12 | 13 | 14 |
|---|---|---|---|---|---|---|
| R | 139.5526 | −708.9518 | −160.3254 | 44.7074 | −51.1453 | 67.4623 |
| k | 0 | 0 | −1.741494E+00 | 2.106352E−01 | −4.056239E+00 | −2.345308E−01 |
| A | 3.721398E−07 | 5.741561E−07 | −5.068600E−08 | −2.592711E−06 | −1.095422E−06 | 3.707208E−06 |
| B | −8.833033E−10 | −7.807911E−10 | −1.547420E−12 | 1.561168E−09 | 1.056786E−09 | −1.707461E−09 |
| C | 2.188937E−13 | 1.456604E−13 | 1.353758E−16 | −9.448078E−13 | −2.610456E−13 | 1.128867E−12 |

Table 19 shows XY polynomial surface data in Example 5.

TABLE 19

| SuNo | 8 | 10 | 11 |
|---|---|---|---|
| R | −149.8538613 | −149.8538613 | −87.81028458 |
| k | −9.49E−01 | −9.49E−01 | −8.69E+00 |
| C-x4 | −3.88363E−08 | −3.88363E−08 | −1.02889E−06 |
| C-x2y2 | −1.13963E−07 | −1.13963E−07 | −1.75497E−06 |
| C-y4 | −6.28751E−08 | −6.28751E−08 | −7.50426E−07 |
| C-x6 | −5.59735E−12 | −5.59735E−12 | 5.88407E−12 |
| C-x4y2 | 5.17167E−12 | 5.17167E−12 | 6.83371E−10 |
| C-x2y4 | 7.49689E−12 | 7.49689E−12 | 6.69161E−10 |
| C-y6 | 1.85702E−12 | 1.85702E−12 | 1.73491E−10 |
| C-x8 | 6.74954E−16 | 6.74954E−16 | 1.05438E−12 |
| C-x6y2 | −1.43803E−15 | −1.43803E−15 | −1.74961E−13 |
| C-x4y4 | −3.23469E−15 | −3.23469E−15 | −1.33036E−13 |
| C-x2y6 | −1.69545E−15 | −1.69545E−15 | −1.26357E−13 |
| C-y8 | −3.05496E−16 | −3.05496E−16 | −2.33671E−14 |

FIG. 19 is a cross-sectional view of the optical device 50 in Example 5.

The optical device 50 includes the prism PR, the lens 41, the first internal reflection element 42, and the mirror element 43. The first internal reflection element 42 is formed by integrating the first optical element 42a and the second optical element 42b. The mirror element 43 faces the first internal reflection element 42.

The first optical element 42a has the first transmissive surface 5a, the third reflective surface 4c, and the second transmissive surface 5b. The third reflective surface 4c is the concave internal reflective surface W1. In the first optical element 42a, the refractive surface W3 through which incident light and reflected light pass is different between the first transmissive surface 5a and the second transmissive surface 5b. The first transmissive surface 5a, the third reflective surface 4c, and the second transmissive surface 5b each have a positive power.

The second optical element 42b has the first reflective surface 4a and the third transmissive surface 5c. The first reflective surface 4a is the concave internal reflective surface W1. In the second optical element 42b, the refractive surface W3 through which incident light and reflected light pass is common to the third transmissive surface 5c. The first aperture stop ST1 is disposed at the first reflective surface 4a. The second aperture stop ST2 is disposed at the third transmissive surface 5c. Between the first reflective surface 4a and the third reflective surface 4c, the first light-absorbing member AB1 is disposed to lie along a step spatially.

The mirror element 43 has the second reflective surface 4b that is the surface reflective surface W4.

The optical device 50 has the third transmissive surface 5c, the first reflective surface 4a, the third transmissive surface 5c, the second reflective surface 4b, the first transmissive surface 5a, the third reflective surface 4c, and the second transmissive surface 5b in order from the reduction side to the magnification side on the optical path. The third transmissive surface 5c, the first transmissive surface 5a, and the second transmissive surface 5b are disposed on the second reflective surface 4b side. The third reflective surface 4c is disposed on the first reflective surface 4a side.

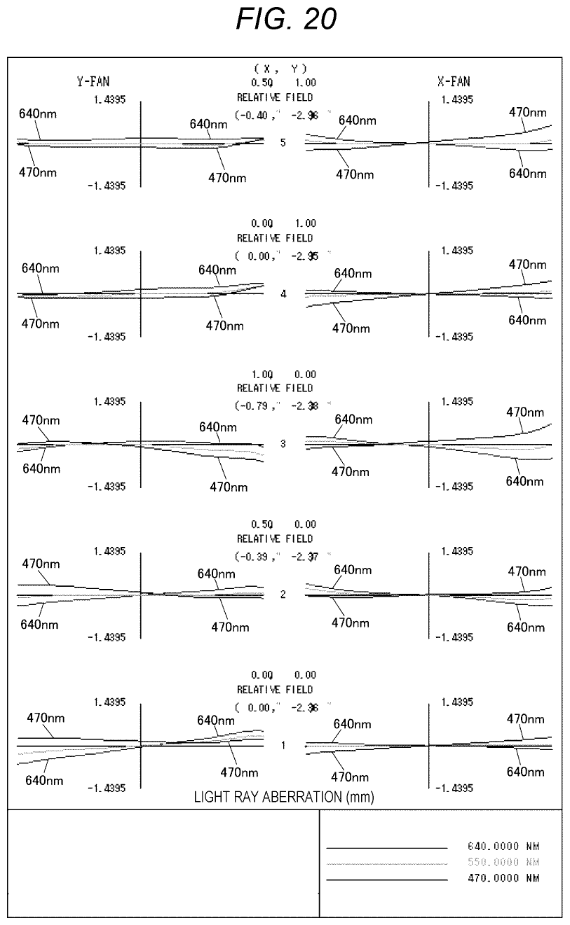

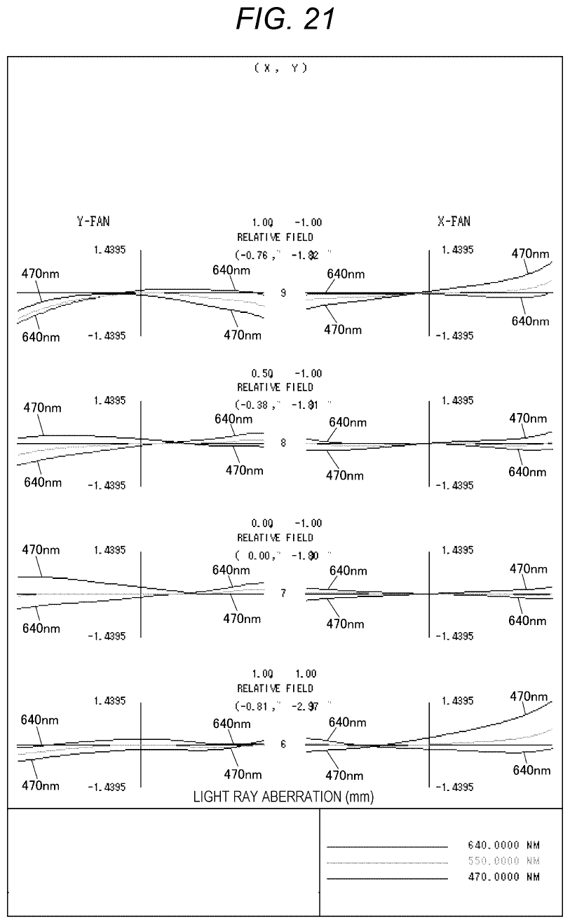

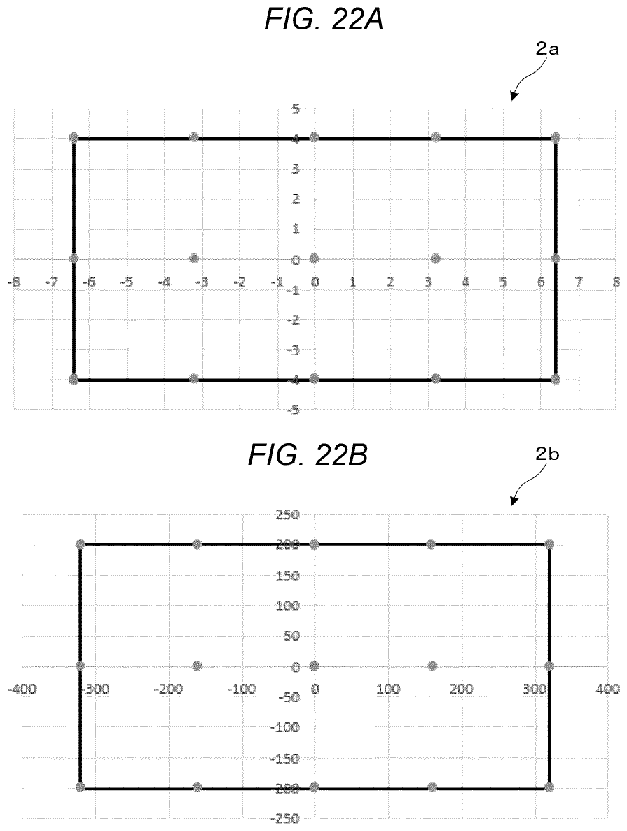

FIGS. 20 and 21 show lateral aberration characteristics of the optical device 50 or the projection optical system 40 in Example 5. FIG. 22 shows a relationship between the display surface 2a of the liquid crystal panel 29G and the projection surface 2b of the screen SC in Example 5.

### Example 6

Table 20 shows optical surface data in Example 6. Terms in Table 20 are shown below.
OM1=SBSL7_OHARA
OM3=Z-330R
OM6=refractive index; 1.487490, Abbe number; 70.41

TABLE 20

| SuNo | SuTy | R | D | Mt | SuFu | Ar |
|---|---|---|---|---|---|---|
| 1 | SP | INF | 9.5000 | | DK | 7.5472 |
| 2 | SP | INF | 25.9100 | OM1 | DK | 9.7316 |
| 3 | SP | INF | 2.0000 | | DK | 13.7947 |
| 4 | SP | INF | 1.7952 | | DK | 29.5718 |
| 5 | NP | −305.9334 | 4.4443 | OM6 | DK | 29.8081 |
| 6 | NP | −106.1521 | 0.1000 | | DK | 29.9102 |
| 7 | SP | INF | T-C | | DK | 30.0793 |
| 8 | XY-FS | −153.7023 | T-C | | RH | 34.0569 |
| 9 | XY-FS | −76.1137 | T-C | | RH | 51.6330 |
| 10 | NP | 42.5040 | T-C | OM3 | DK | 45.1329 |
| 11 | XY-FS | −57.3718 | T-C | OM3 | RH | 53.8924 |
| 12 | NP | 350.6869 | T-C | | DK | 48.1930 |
| 13 | SP | INF | T-C | | DK | 169.8454 |
| 14 | SP | INF | −428.0000 | | DK | 169.8454 |
| 15 | SP | INF | 0.0000 | | DK | 773.3410 |

Table 21 shows an eccentricity setting of Example 6.

TABLE 21

| SuNo | Ec | XEc | YEc | ZEc | αRo |
|---|---|---|---|---|---|
| 1 | nr | — | — | — | — |
| 2 | N/A | — | — | — | — |
| 3 | N/A | — | — | — | — |
| 4 | nr | — | −20.3152 | — | — |
| 5 | N/A | — | — | — | — |
| 6 | N/A | — | — | — | — |
| 7 | dc & re | — | — | 3.0000 | — |
| 8 | dc & re | — | — | 119.4592 | −16.1328 |
| 9 | dc & re | — | 93.4176 | 0.0000 | 36.2218 |
| 10 | dc & re | — | 93.2930 | 52.2173 | −8.1585 |
| 11 | dc & re | — | 125.7550 | 117.3741 | 32.8682 |
| 12 | dc & re | — | 93.2930 | 52.2173 | −14.6886 |
| 13 | nr | — | — | 52.2173 | — |
| 14 | dc & re | — | — | — | — |
| 15 | N/A | — | — | — | — |

Table 22 shows aspherical surface data in Example 6.

TABLE 22

| SuNo | 5 | 6 | 10 | 12 |
|---|---|---|---|---|
| R | −0.0033 | −0.0094 | 0.0235 | 0.0029 |
| k | −3.059334E+02 | −1.061521E+02 | 4.250405E+01 | 3.506869E+02 |
| A | 0.000000E+00 | 0.000000E+00 | −3.232399E−01 | 4.502167E+01 |
| B | 2.767998E−06 | 1.772463E−06 | −1.711107E−06 | 2.614078E−06 |
| C | −1.877724E−09 | −1.464826E−09 | 5.830137E−10 | −6.789367E−10 |
| D | 4.69008E−13 | 2.98425E−13 | −1.64402E−13 | 1.55824E−13 |

Table 23 shows XY polynomial surface data in Example 6.

TABLE 23

| SuNo | 8 | 9 | 11 |
|---|---|---|---|
| R | −153.7022973 | −76.11373632 | −57.37178972 |
| k | −1.75E+00 | −7.84E−01 | −9.13E−01 |
| C-x4 | −6.14447E−08 | −5.04573E−07 | 5.97035E−07 |
| C-x2y2 | −1.22579E−07 | 3.84921E−09 | −3.71172E−06 |
| C-y4 | −6.15013E−08 | −1.97105E−06 | −2.14479E−07 |
| C-x6 | −2.24865E−13 | −9.47912E−10 | −1.74977E−09 |
| C-x4y2 | −1.57103E−12 | 6.46022E−10 | −2.12943E−10 |
| C-x2y4 | −1.33344E−12 | 1.71838E−10 | 4.27392E−10 |
| C-y6 | −4.48952E−13 | 4.56109E−10 | −2.64272E−10 |
| C-x8 | −6.52794E−17 | 8.18747E−13 | 1.26535E−12 |
| C-x6y2 | 1.80997E−16 | 2.97945E−13 | 1.57809E−12 |
| C-x4y4 | 1.7432E−16 | −2.73843E−13 | 4.5708E−13 |
| C-x2y6 | −5.70596E−17 | −5.6652E−14 | 1.80449E−13 |
| C-y8 | −6.55454E−18 | −4.82723E−14 | 6.16036E−14 |

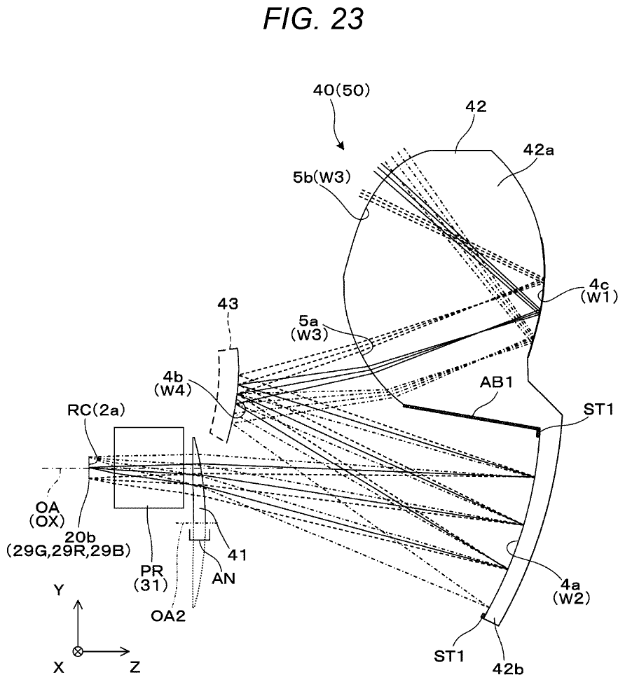

FIG. 23 is a cross-sectional view of the optical device 50 in Example 6.

The optical device 50 includes the prism PR, the lens 41, the first internal reflection element 42, and the mirror element 43. The first internal reflection element 42 is formed by integrating the first optical element 42a and the second optical element 42b. The mirror element 43 faces the first internal reflection element 42.

The first optical element 42a has the first transmissive surface 5a, the third reflective surface 4c, and the second transmissive surface 5b. The third reflective surface 4c is the concave internal reflective surface W1. In the first optical element 42a, the refractive surface W3 through which incident light and reflected light pass is different between the first transmissive surface 5a and the second transmissive surface 5b. The first transmissive surface 5a, the third reflective surface 4c, and the second transmissive surface 5b each have a positive power.

The second optical element 42b has the first reflective surface 4a. The first reflective surface 4a is the concave surface reflective surface W2. The first aperture stop ST1 is disposed at the first reflective surface 4a. Between the first reflective surface 4a and the third reflective surface 4c, the first light-absorbing member AB1 is disposed to lie along a step spatially.

The mirror element 43 has the second reflective surface 4b that is the surface reflective surface W4.

The optical device 50 has the first reflective surface 4a, the second reflective surface 4b, the first transmissive surface 5a, the third reflective surface 4c, and the second transmissive surface 5b in order from the reduction side to the magnification side on the optical path. The first transmissive surface 5a and the second transmissive surface 5b are disposed on the first reflective surface 4a side. The third reflective surface 4c is disposed on the side opposite to the first reflective surface 4a.

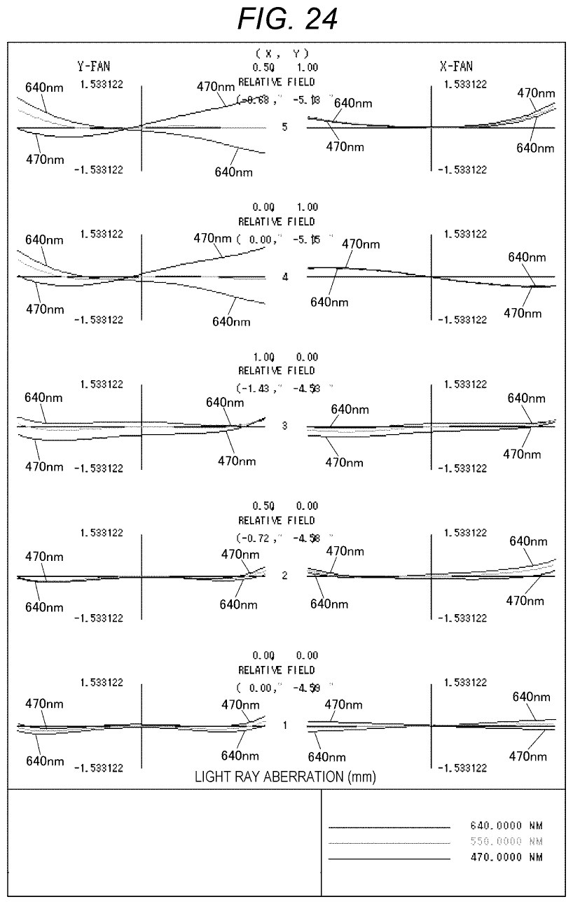

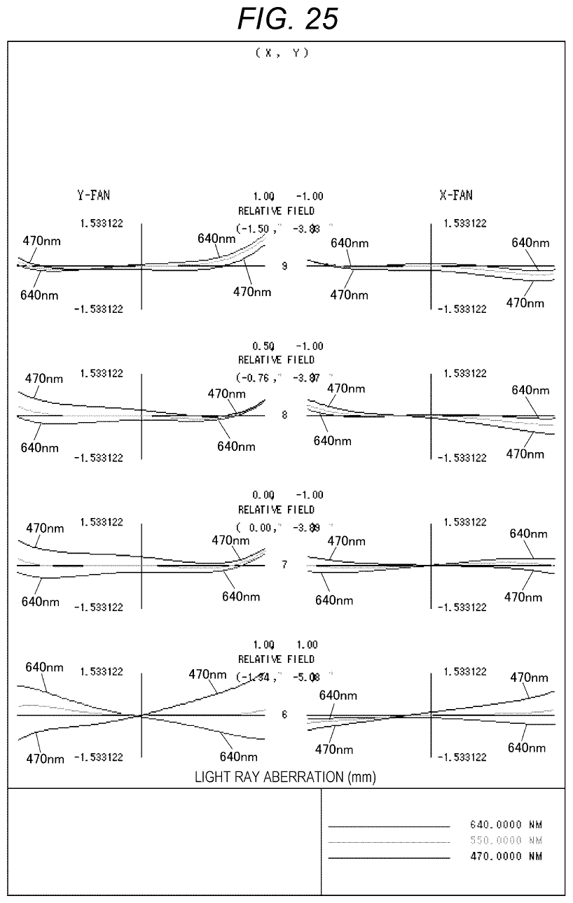

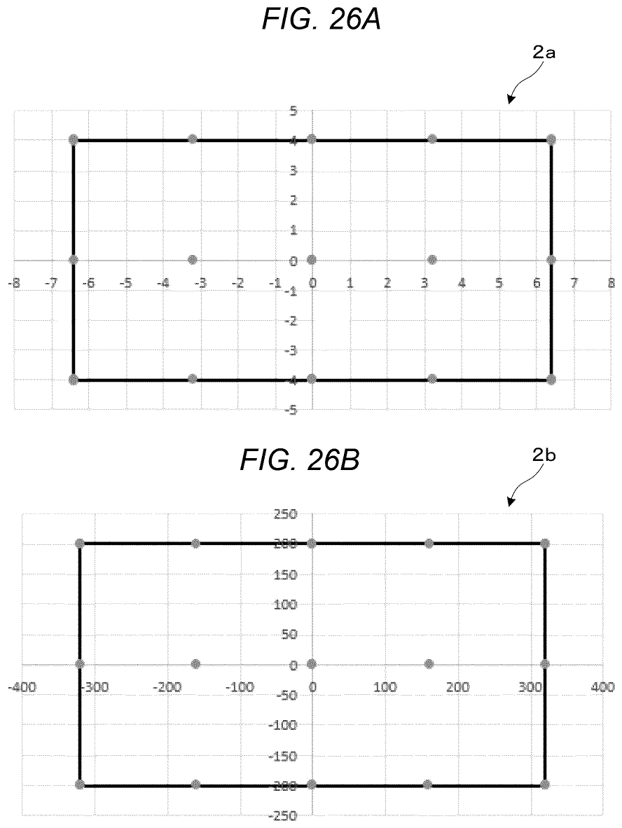

FIGS. 24 and 25 show lateral aberration characteristics of the optical device 50 or the projection optical system 40 in Example 6. FIG. 26 shows a relationship between the display surface 2a of the liquid crystal panel 29G and the projection surface 2b of the screen SC in Example 6.

### Fifth Embodiment

Hereinafter, an optical device and the like according to a fifth embodiment will be described. The optical device according to the fifth embodiment is obtained by partially changing the optical device according to the first embodiment, and descriptions of portions common to the optical device according to the first embodiment will be omitted.

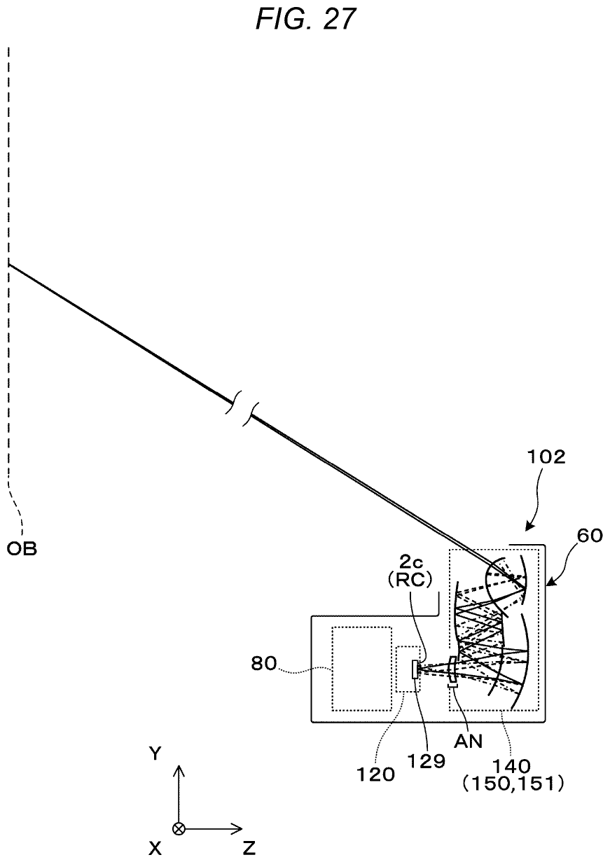

FIG. 27 shows a camera 102 incorporating an optical device 150 according to the fifth embodiment. As shown in FIG. 27, the camera 102 includes the optical system portion 60 that captures an image of an object OB and the circuit device 80 that controls an operation of the optical system portion 60. The optical system portion 60 includes an imaging optical system 140 that forms the image of the object OB and an image detection device 120 that detects the image.

The image detection device 120 includes an imaging element 129. The imaging element 129 is disposed at the reduction-side conjugate surface RC of the optical device 150. In the embodiment, the optical device 150 is an imaging optical device 151. The optical device 150 shown as an example in FIG. 27 has the same configuration as the optical device 50 in Example 1 (see FIG. 3). The optical device 50 in Examples 2 to 6 (see FIGS. 7, 11, 15, 19, and 23) may also be applied to the optical device 150. In the imaging optical device 151, the prism PR constituting the optical device 50 in Examples 1 to 6 is omitted or replaced with a cover glass (not shown).

The optical device 150 forms the image of the object OB by the imaging optical system 140 and acquires the image detected by an imaging surface 2c of the imaging element 129.

### Other Matters

The structures described above are presented by way of examples, and can be changed in various manners within a scope in which the same functions can be obtained.

For example, in each Example, one or more lenses having substantially no power can be added to the optical device 50.

A target to be magnified and projected by the optical device 50 is not limited to an image formed by the liquid crystal panels 29R, 29G, and 29B, and an image formed by a light modulation unit such as a digital micromirror device can be magnified and projected.

The second light-absorbing member AB2, the second aperture stop ST2, and the like may be omitted.

The optical device 50 can be applied to a head-up display, an in-vehicle projection system, and the like.

### SUMMARY OF DISCLOSURE

The disclosure will be summarized below as appendices.

### Appendix 1

An optical device including:
a first reflective surface having a power;
a second reflective surface disposed on a magnification side of the first reflective surface and having a power; and
a first optical element disposed on a magnification side of the second reflective surface, in which
the first optical element has a first transmissive surface, a third reflective surface having a concave shape in an incident light ray direction, and a second transmissive surface different from the first transmissive surface, which are disposed in order from a reduction side to the magnification side, and
at least one of the first transmissive surface, the third reflective surface, and the second transmissive surface has a power.

Light ray control is using facilitated refractive powers of the first transmissive surface and the second transmissive surface close to the third reflective surface that is an internal reflective surface of the first optical element, which is advantageous for size reduction and performance improvement. The first transmissive surface and the second transmissive surface can provide different functions to an incident surface and an exit surface of the first optical element, and thus optical performance can be improved. In addition, since the third reflective surface is the internal reflective surface, the third reflective surface can be reduced in size, and thus the entire optical system can be reduced in size. Based on the above, a focal length of the optical device can be shortened and a size of the optical device can be reduced.

### Appendix 2

The optical device according to Appendix 1, in which an intermediate image is formed between the first transmissive surface and the third reflective surface.

Accordingly, the intermediate image is formed on a reduction side optical path of the concave third reflective surface, the intermediate image is re-imaged by the third reflective surface, and thus a focal length can be shortened.

### Appendix 3

The optical device according to Appendix 1 or 2, in which the first transmissive surface, the third reflective surface, and the second transmissive surface each have a power.

### Appendix 4

The optical device according to any one of Appendices 1 to 3, in which the third reflective surface has a positive power.

### Appendix 5

The optical device according to any one of Appendices 1 to 4, further including a first aperture stop disposed at the first reflective surface.

In particular, when the optical device is used as a projection optical system, an unnecessary stray reflection in the optical system can be prevented by regulating light emitted from a display device at an initial stage of the optical system.

### Appendix 6

The optical device according to any one of Appendices 1 to 5, further including a positive lens disposed between a reduction-side conjugate surface and the first reflective surface.

Accordingly, the reduction side can be made telecentric. In addition, it is possible to reduce a size of the entire optical system by reducing light beam spread.

### Appendix 7

The optical device according to Appendix 6, further including a moving mechanism configured to move the lens along a lens optical axis of the lens.

Accordingly, a focus function can be implemented.

### Appendix 8

The optical device according to Appendix 6 or 7, in which the lens optical axis of the lens is shifted to a side opposite to a magnification-side conjugate surface relative to a center of the reduction-side conjugate surface.

Accordingly, a position of the first reflective surface relative to a central axis of the reduction-side conjugate surface can be disposed spatially on a lower side opposite to the magnification-side conjugate surface, and thus a height of the optical system disposed above the first reflective surface can be reduced.

### Appendix 9

The optical device according to any one of Appendices 1 to 8, further including a first light-absorbing member disposed between the first reflective surface and the third reflective surface, the first light-absorbing member being configured to prevent light reflected by the first reflective surface and light reflected by the third reflective surface from leaking to an unintended optical path and returning to an intended optical path from another location.

Accordingly, it is possible to shield unnecessary light that is reflected by the first reflective surface and the third reflective surface in the vicinity, peripheries thereof, and the like and causes stray light.

### Appendix 10

The optical device according to any one of Appendices 1 to 4, further including:
a second optical element having the first reflective surface and a third transmissive surface that transmits both incident light incident on the first reflective surface and reflected light reflected by the first reflective surface; and
a second aperture stop disposed at the third transmissive surface.

Since an incident light ray onto the second optical element and an exit light ray pass through the third transmissive surface that is the same refractive surface, light ray control that cannot be implemented by surface reflections is enabled, and optical performance can be improved while saving space. By providing an aperture stop function to the internal-reflection-type second optical element having the first reflective surface, light ray control at an aperture stop position is facilitated, which is advantageous for improving optical performance.

### Appendix 11

The optical device according to any one of Appendices 1 to 9, further including a second optical element having the first reflective surface and a third transmissive surface that transmits both incident light incident on the first reflective surface and reflected light reflected by the first reflective surface.

Since an incident light ray onto the second optical element and an exit light ray pass through the third transmissive surface that is the same refractive surface, light ray control that cannot be implemented by surface reflections is enabled, and optical performance can be improved while saving space.

### Appendix 12

The optical device according to Appendix 11, in which the first optical element and the second optical element are an integrated internal reflection element.

Accordingly, since the first and second optical elements are formed of the same element, it is possible to reduce cost and improve assembly accuracy.

### Appendix 13

The optical device according to any one of Appendices 1 to 7, in which
the first optical element further has the second reflective surface, and
the second reflective surface is disposed between the first transmissive surface and the third reflective surface.

Accordingly, the first optical element has two internal reflective surfaces and two refractive surfaces, thus it is possible to reduce the number of components and to reduce a size of the first optical element while ensuring assembly accuracy.

### Appendix 14

The optical device according to Appendix 13, further including:
a second optical element having the first reflective surface and a third transmissive surface that transmits both incident light incident on the first reflective surface and reflected light reflected by the first reflective surface, in which
the first optical element and the second optical element are separate internal reflection elements spaced apart from each other.

### Appendix 15

The optical device according to any one of Appendices 1 to 7, further including:
a second optical element having the first reflective surface and a third transmissive surface that transmits both incident light incident on the first reflective surface and reflected light reflected by the first reflective surface;
a third optical element having a fourth reflective surface disposed on the magnification side of the second reflective surface; and
a fifth reflective surface disposed between the fourth reflective surface and the first transmissive surface, in which
the first optical element, the second optical element, and the third optical element are an integrated internal reflection element.

Since the plurality of reflective surfaces are provided in a direction of magnified projection relative to the central axis of the reduction-side conjugate surface, it is possible to minimize a reflection angle and prevent a decrease in optical performance. Since the first to third optical elements are formed of the same element, it is possible to reduce cost and improve assembly accuracy.

### Appendix 16

The optical device according to Appendix 15, further including a second light-absorbing member disposed on a surface opposite to the fourth reflective surface between the first reflective surface and the third reflective surface.

Accordingly, it is possible to shield unnecessary light that is reflected by the first reflective surface and the third reflective surface and causes stray light.

### Appendix 17

The optical device according to Appendix 16, in which
the third reflective surface is disposed on the first reflective surface side, and
the third transmissive surface, the fourth reflective surface, the first transmissive surface, and the second transmissive surface are disposed on the second reflective surface side.

Accordingly, an internal reflective surface, a surface reflective surface, and a refractive surface can be disposed at the internal reflection element, which is advantageous for size reduction.

### Appendix 18

The optical device according to any one of Appendices 15 to 17, in which the second reflective surface and the fifth reflective surface are disposed on a reduction-side conjugate surface side relative to the internal reflection element and are integrally formed.

Accordingly, it is possible to reduce the size and cost of the optical system.

### Appendix 19

A projector including:
the optical device according to any one of Appendices 1 to 18; and
an image forming unit configured to form an image on a reduction-side conjugate surface of the optical device.

Accordingly, the projector including the optical device can thus be reduced in size.

### Appendix 20

An imaging apparatus including:
the optical device according to any one of Appendices 1 to 18; and
an imaging element disposed at a reduction-side conjugate surface of the optical device.

Accordingly, the imaging apparatus including the optical device can thus be reduced in size.

What is claimed is:

1. An optical device comprising:
a first reflective surface having a power;
a second reflective surface disposed on a magnification side of the first reflective surface and having a power; and
a first optical element disposed on a magnification side of the second reflective surface, wherein
the first optical element has a first transmissive surface, a third reflective surface having a concave shape in an light incident ray direction, and a second transmissive surface different from the first transmissive surface, which are disposed in order from a reduction side to the magnification side, and
at least one of the first transmissive surface, the third reflective surface, and the second transmissive surface has a power.

2. The optical device according to claim 1, wherein
an intermediate image is formed between the first transmissive surface and the third reflective surface.

3. The optical device according to claim 1, wherein
the first transmissive surface, the third reflective surface, and the second transmissive surface each have a power.

4. The optical device according to claim 1, wherein
the third reflective surface has a positive power.

5. The optical device according to claim 1, further comprising:
a first aperture stop disposed at the first reflective surface.

6. The optical device according to claim 1, further comprising:
a positive lens disposed between a reduction-side conjugate surface and the first reflective surface.

7. The optical device according to claim 6, further comprising:
a moving mechanism configured to move the lens along a lens optical axis of the lens.

8. The optical device according to claim 6, wherein
a lens optical axis of the lens is shifted to a side opposite to a magnification-side conjugate surface relative to a center of the reduction-side conjugate surface.

9. The optical device according to claim 1, further comprising:
a first light-absorbing member disposed between the first reflective surface and the third reflective surface, the first light-absorbing member being configured to prevent light reflected by the first reflective surface and light reflected by the third reflective surface from leaking to an unintended optical path and returning to an intended optical path from another location.

10. The optical device according to claim 1, further comprising:
a second optical element having the first reflective surface and a third transmissive surface that transmits both incident light incident on the first reflective surface and reflected light reflected by the first reflective surface; and
a second aperture stop disposed at the third transmissive surface.

11. The optical device according to claim 1, further comprising:
a second optical element having the first reflective surface and a third transmissive surface that transmits both incident light incident on the first reflective surface and reflected light reflected by the first reflective surface.

12. The optical device according to claim 11, wherein
the first optical element and the second optical element are an integrated internal reflection element.

13. The optical device according to claim 1, wherein
the first optical element further has the second reflective surface, and
the second reflective surface is disposed between the first transmissive surface and the third reflective surface.

14. The optical device according to claim 13, further comprising:
a second optical element having the first reflective surface and a third transmissive surface that transmits both incident light incident on the first reflective surface and reflected light reflected by the first reflective surface, wherein
the first optical element and the second optical element are separate internal reflection elements spaced apart from each other.

15. The optical device according to claim 1, further comprising:
a second optical element having the first reflective surface and a third transmissive surface that transmits both incident light incident on the first reflective surface and reflected light reflected by the first reflective surface;
a third optical element having a fourth reflective surface disposed on the magnification side of the second reflective surface; and
a fifth reflective surface disposed between the fourth reflective surface and the first transmissive surface, wherein
the first optical element, the second optical element, and the third optical element are an integrated internal reflection element.

16. The optical device according to claim 15, further comprising:
a second light-absorbing member disposed on a surface opposite to the fourth reflective surface between the first reflective surface and the third reflective surface.

17. The optical device according to claim 16, wherein
the third reflective surface is disposed on the first reflective surface side, and
the third transmissive surface, the fourth reflective surface, the first transmissive surface, and the second transmissive surface are disposed on the second reflective surface side.

18. The optical device according to claim 15, wherein
the second reflective surface and the fifth reflective surface are disposed on a reduction-side conjugate surface side relative to the internal reflection element and are integrally formed.

19. A projector comprising:
the optical device according to claim 1; and
an image forming unit configured to form an image on a reduction-side conjugate surface of the optical device.

20. An imaging apparatus comprising:
the optical device according to claim 1; and
an imaging element disposed at a reduction-side conjugate surface of the optical device.
